(19) United States
(12) Patent Application Publication
(10) Pub. No.: US 2026/0134408 A1
(43) Pub. Date: May 14, 2026

(54) Orchestration Engine and System, and Method for Controlling Connections

(71) Applicant: Alnaaz Pty Ltd, Victoria (AU)

(72) Inventors: Rupinder Sohal, Victoria (AU); Vineet Chauhan, Victoria (AU); Jeevesh Pareek, Victoria (AU)

(21) Appl. No.: 19/386,544

(22) Filed: Nov. 12, 2025

(30) Foreign Application Priority Data
Nov. 12, 2024 (AU) 2024903711
Dec. 1, 2024 (AU) 2024903976

(51) Int. Cl. G06Q 10/42

(52) U.S. Cl. CPC G06Q 10/42

(57) ABSTRACT

Described herein is a platform that implements multi-signal matching with trust and risk scoring, in which a compatibility score S combines proximity, availability, skills, language, pricing fairness, trust and verification, and activity signals, while a risk score R estimates safety and fraud likelihood; together, S and R guide marketplace ranking and automated orchestration. The system further provides efficient multilingual delivery using i18n versioned language bundles with ETag-based delta updates, and secure WebRTC signalling that employs sequence numbers, idempotency, and encrypted SDP and message payloads. AI support is grounded in curated knowledge base fusion with reversible personally identifiable information (PII) redaction, a policy engine enforces minimum pricing before payment, and wallet and referral changes are applied as atomic transactional updates.

### TECHNICAL FIELD

The present disclosure broadly relates to service provider software platforms and, more particularly, to a system for, and a method of, matching a service request user and a collocated service provider. The present disclosure also relates to connection engines, and in some embodiments to risk-aware, privacy-preserving orchestration engines that automatically form and/or suppresses connections between users and/or devices.

### BACKGROUND

Online platforms increasingly connect individuals who wish to obtain or provide services, including ride-sharing, accommodation, home care, tutoring, personal assistance, and travel-related escort or support services. Many of these platforms use computer-implemented recommendation systems to suggest potential counterparties based on simple attributes such as location, availability, or stated preferences. In typical arrangements, once a user is presented to another user as a recommendation or search result, the platform exposes profile information and contact or messaging capabilities according to static business rules or broad privacy settings selected by the user.

Existing systems generally treat recommendation, trust and safety checks, identity verification, pricing rules, and privacy controls as separate functions. A common pattern is that matching or search results are generated using straightforward filters and relevance scores without incorporating a formal, calibrated assessment of risk for each participant or for the specific combination of participants in a given context. Basic checks may be performed at registration or at payment time, and certain high-risk accounts may be suspended entirely, but the decision whether two particular parties should be connected, and what information is appropriate to reveal to them about each other at each stage, is not managed by a unified, continuous decision process.

Conventional platforms also often expose personal information or communication channels too early in the interaction, or maintain a coarse-grained “all or nothing” approach. For example, once a user appears in a search result or accepts a connection request, the counterpart may immediately see names, photos, and contact details, even if the underlying risk for that pairing or context has not been robustly evaluated. Conversely, attempts to increase safety sometimes rely on manual review or blanket restrictions that do not scale or adapt well to different levels of risk and different transaction scenarios.

Furthermore, when new information emerges after an initial match has been made, such as chargebacks, complaints, abusive messages, anomalous activity, or updated verification results, many existing systems lack a structured mechanism to re-evaluate the specific matches affected and, where needed, to change the status of those matches, adjust what information is visible, or suspend ongoing interactions. Decisions are often opaque: platforms may not maintain machine-readable records showing which signals led to a particular match, which policies were applied, or which factors caused a later intervention. This makes it difficult to audit or explain decisions, to tune automated safeguards, or to demonstrate compliance with legal and regulatory expectations.

At the same time, there is growing demand, from both users and regulators, for platforms to implement more sophisticated, transparent, and privacy-preserving trust frameworks. These frameworks are expected to weigh multiple signals, calibrate risk rather than apply simple heuristics, limit exposure of personal information until it is justified, log how and why decisions are made, and respond promptly when risk changes. Traditional recommendation engines that simply rank candidates by relevance, without integrated risk modelling, staged information disclosure, and dynamic rollback capabilities, are not designed to meet these requirements.

One example application is when travellers require support, for example if they are inexperienced travellers or do not understand a language. One solution for this is for travellers to travel with friends or family members. Alternatively, such travellers can hire a caretaker or companion traveller, however this can be prohibitively expensive.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

Described herein is a platform that implements multi-signal matching with trust and risk scoring, in which a compatibility score S combines proximity, availability, skills, language, pricing fairness, trust and verification, and activity signals, while a risk score R estimates safety and fraud likelihood; together, S and R guide marketplace ranking and automated orchestration. The system further provides efficient multilingual delivery using i18n versioned language bundles with ETag-based delta updates, and secure WebRTC signalling that employs sequence numbers, idempotency, and encrypted SDP and message payloads. AI support is grounded in curated knowledge base fusion with reversible personally identifiable information (PII) redaction, a policy engine enforces minimum pricing before payment, and wallet and referral changes are applied as atomic transactional updates.

In some embodiments, a unique method and system to support not only travellers that require support is facilitated by applying the technology solutions described herein. Indeed any type of application for users requiring a specific service that can be described by defining certain service parameters may be supported by the systems and methods described herein, and in particular where users are connected to one another. The methods described support multiple users who can take on the role of a service requestor or a service provider, and the systems described are able to determine a match and facilitate a suitable connection.

The techniques described in this specification address some of the existing safety, security and/or transparency shortcomings of platforms that connect users by providing a computer-implemented decision engine that, for each potential interaction between parties on a platform, jointly considers a combination of factors, including one or more of compatibility, risk, context, privacy conditions, and/or subsequent signals. The engine continuously decides whether parties should be connected at all, what information can be revealed at each stage, and how to adjust or revoke connections in response to updated risk, using a unified and auditable orchestration framework.

In one aspect, a computer-implemented method for controlling connection of users on a networked platform, the method comprising, by one or more processors:
receiving, from a first user, a request for a prospective interaction in a defined context; identifying a set of candidate counterpart users;
for each candidate counterpart user, computing a compatibility score based on attributes of the first user, the candidate counterpart user and the context;
for each of the first user and each candidate counterpart user, computing a respective profile risk score using a machine-learned model trained with monotonic constraints such that increases in verification or positive history do not increase the profile risk score and increases in adverse indicators do not decrease the profile risk score;
for each candidate counterpart user, computing a pairwise risk score for the prospective interaction as a function of at least the corresponding profile risk scores and one or more context factors; by an orchestration engine, applying one or more decision policies to the compatibility score, the profile risk scores and the pairwise risk score to select, for each candidate counterpart user, one of a plurality of connection states comprising at least an approved state, a conditional state and a blocked state;
and by the orchestration engine, controlling disclosure of user information between the first user and the candidate counterpart user in dependence on the selected connection state, including causing only redacted or pseudonymous information to be disclosed while in one or more initial states and causing additional identifying information or communication capabilities to be disclosed only upon transition to one or more authorised connection states.

In another aspect there is provided a service matching system for matching a service request user and a collocated service provider, the system comprising: a matching server with a database of user and service provider data; and a plurality of client devices in communication with the matching server via a communication network, wherein the matching server comprises a processor configured to: receive a match request from the user, the match request comprising match parameters comprising a physical location; retrieve service provider profiles from the database based on the match parameters; compare the match parameters with service provider profile parameters to identify one or more matching service providers; output a service request to the one or more matching service providers; upon receiving a service accept message from a matching service provider, assign a service provider; and connect a client device associated with the match request and a client device associated with the assigned service provider.

In another aspect there is provided a computer-implemented method for matching a user and a collocated service provider, the method comprising: receiving a match request from the user, the match request comprising match parameters comprising a physical location; retrieving service provider profiles from the database based on the match parameters; comparing the match parameters with service provider profile parameters to identify one or more matching service providers; outputting a service request to the one or more matching service providers; upon receiving a service accept message from a matching service provider, assigning a service provider; connecting a client device associated with the match request and a client device associated with the assigned service provider.

Throughout this specification the word “comprise” or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the disclosure are now described by way of example with reference to the accompanying drawings in which:

FIG. 1 is a schematic representation of an embodiment of a service matching system.

FIG. 2 is a block diagram of an example embodiment of a computing device.

FIG. 3 is a flow diagram of a method for matching a user and a collocated service provider.

FIG. 4A is an embodiment of a client user interface for a requestor.

FIG. 4B is an embodiment of a client user interface for a service provider.

FIG. 4C is another embodiment of a client user interface for a requestor secure login.

FIG. 5A is an embodiment of a client user interface for a requestor creating a new request.

FIG. 5B is another embodiment of a client user interface for a requestor creating a request.

FIG. 5C is an embodiment of a client user interface showing booking details for a booked service.

FIG. 6A is an embodiment of a user interface showing the status of service provision.

FIG. 6B is an embodiment of a user interface showing payments received by a service provider.

FIG. 6C is an embodiment of a user interface for providing a review associated with a completed service.

FIG. 7 is a flow diagram illustrating an embodiment of a method for controlling connection of users on a networked platform.

FIG. 8 is a schematic representation of an embodiment of a system configured to perform the method of FIG. 7.

In the drawings, like reference numerals designate similar parts.

### DETAILED DESCRIPTION

Online platforms that mediate interactions between different parties, such as service providers and end users, increasingly rely on networked computing systems to discover, select, and connect those parties. Conventional platforms typically implement matching and search functions using simple filters or heuristic recommendation algorithms operating over user attributes, locations, and availability. In many cases, these mechanisms treat the act of suggesting users to each other as distinct from, and largely independent of, the platform's identity verification, fraud prevention, trust and safety, privacy controls, and audit logging. As a result, the technical behaviour of the system is fragmented: one set of components generates recommendations or search results, another performs registration and payment checks, and another enforces coarse-grained access controls or manual interventions. There is no single, integrated decision mechanism that continuously determines, at the time of each potential interaction, whether two particular parties should be connected at all, what information can safely be exchanged between them, and how those decisions should adapt when underlying risk or context changes.

A first technical problem arises because conventional recommendation engines are not designed to incorporate formally defined and calibrated risk assessments into the matching decision for specific pairs of users. Existing systems may block known bad actors globally, or perform static checks when an account is created or a payment instrument is added, but they generally do not maintain a robust, machine-readable measure of risk for each user based on multiple operational signals, nor do they derive a pairwise risk measure that depends on the combination of users and the specific context of the contemplated interaction. Without such integrated risk modelling, the platform cannot systematically prevent apparently suitable candidates from being shown in contexts where the combination of their attributes, history, and environment presents elevated risk, nor can it automatically downgrade, escalate, or block particular interactions when risk indicators change.

A second technical problem concerns information disclosure and privacy in connection workflows. Traditional platforms often expose personal information (for example, names, photos, locations, and contact details) as soon as a search result is shown, a booking is made, or a connection request is accepted, according to static configuration settings. These implementations lack a fine-grained, state-dependent disclosure mechanism that is tightly coupled with the platform's safety and risk decisions. The absence of such coupling leads to two opposite technical deficiencies: either sensitive data is disclosed too early, before the platform has sufficient confidence in the parties or the match, increasing security and abuse risk; or, to compensate, the platform imposes blanket restrictions that reduce usability and require manual exceptions, which do not scale and are error-prone. There is no general-purpose technical framework in which the decision “what may each party see at this moment” is computed as part of the same automated process that decides “should these parties be connected at all.”

A third technical problem relates to the dynamic nature of risk and trust signals. In real deployments, relevant inputs such as complaints, chargebacks, abusive messages, device or IP anomalies, inconsistent location data, verification outcomes, and third-party alerts may arise after an initial match has been created or while an interaction is ongoing. Conventional architectures seldom provide a mechanism for continuously ingesting such signals, recomputing affected users' risk in a calibrated manner, re-assessing the safety of specific existing matches, and, where necessary, automatically changing the state of those matches. Instead, decisions to suspend or alter interactions are often made manually or according to ad hoc rules, are inconsistently enforced across the system, and are not recorded with sufficient detail to allow later audit or explanation. This creates a technical gap: the platform has no deterministic, system-wide process to roll back or adjust existing connections and associated information flows in response to updated risk assessments.

A fourth technical problem lies in the lack of structured, machine-readable decision records that link each match, disclosure, and intervention to the signals, thresholds, configurations, and models that produced it. Many existing systems can log events for debugging or billing purposes, but they do not maintain comprehensive decision artefacts capturing the computed scores, applied policies, reasons, and configuration versions for each outcome. This omission makes it technically difficult to reconstruct system behaviour at a later time, to verify that automated safeguards worked as intended, to validate model performance, or to demonstrate compliance with internal rules or external regulatory requirements.

A further problem involves the trustworthiness of endpoints through which matches are formed, instructions are delivered, and personal information is displayed or captured. When the platform is accessed through arbitrary, user-controlled smartphones or general-purpose computers, the platform has limited technical ability to constrain how sensitive data is stored, forwarded, or combined with other applications. It cannot readily ensure that match decisions, disclosure rules, and proof-of-service or proof-of-presence signals are enforced and reported by trusted hardware or software components. This weakens the overall effectiveness of any centralised decision framework, because enforcement at the edge of the system is unreliable and susceptible to tampering.

The systems and methods described herein involve an integrated decision engine and associated client and server components that: compute structured compatibility scores and calibrated risk scores for individual users and user pairs in context; apply defined policies and thresholds to jointly determine whether parties should be connected, in what state, and with what level of information disclosure; continuously monitor for new signals and, when they arise, recompute risk and update or revoke existing connections according to deterministic rollback conditions; generate and persist detailed, machine-readable decision records for audit and analysis; and, in some embodiments, embody parts of this logic in specialised server appliances, kiosks, and handheld or installed terminals that act as trusted enforcement points for the match, risk, and disclosure rules. These technical measures produce a coordinated, privacy-preserving control mechanism that is not achieved by known recommendation engines or by ad hoc combinations of conventional components.

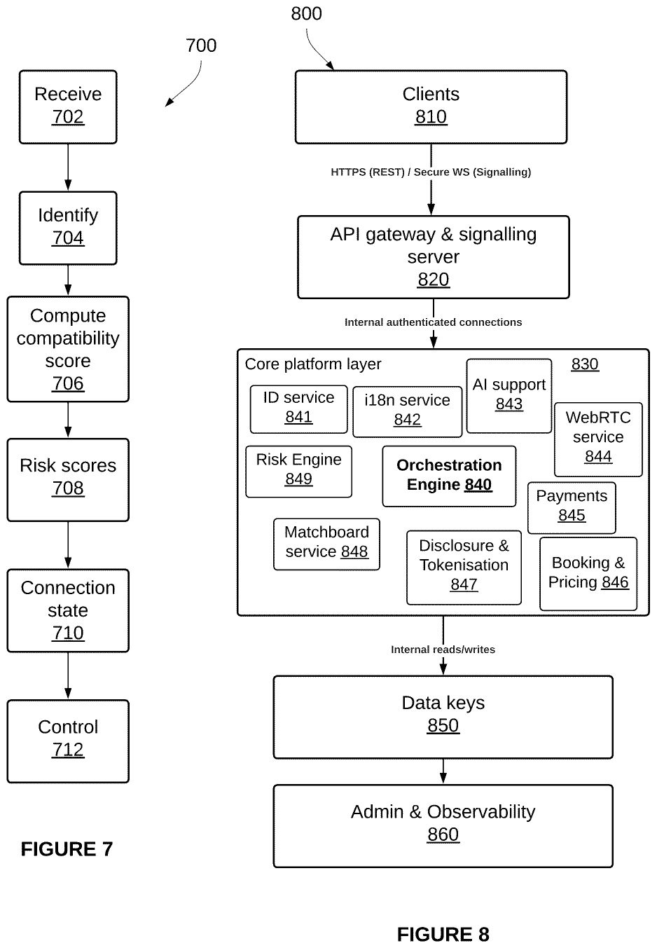

FIG. 7 is a flow diagram illustrating an example method 700 implemented by a platform to control connection of users on a networked system. In FIG. 7, the method 700 begins at step 702, in which the system receives, from a first user, a request for a prospective interaction. The request may include contextual information such as time, route, location, service type, or other requirements, and is received via one of the authenticated client devices communicating with the backend platform.

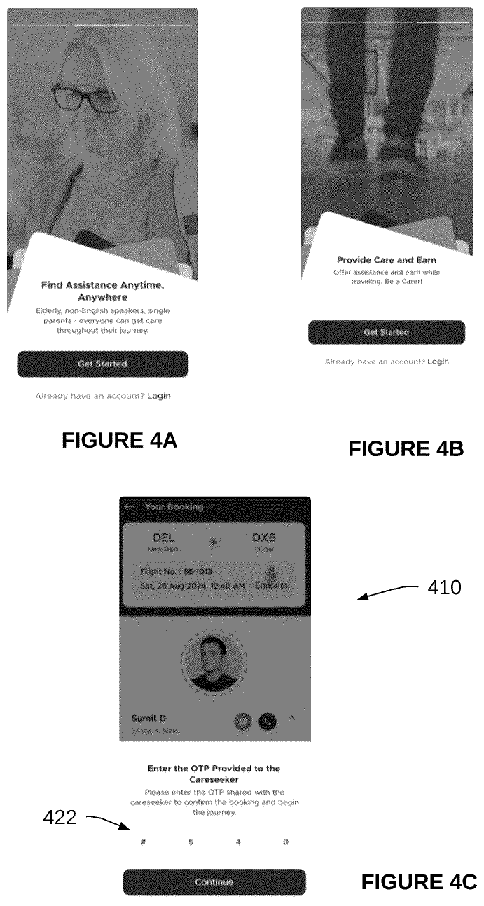

In some embodiments, authentication is provided by an OTP-based flow in which signup or login triggers an OTP sent to a verified channel such as email or phone (see FIG. 4C). Successful OTP verification results in issuance of a JWT which is required for subsequent operations. During or after OTP verification, the system assigns a user role, such as “requestor” or “responder”, using either explicit selection or a lightweight classifier that considers device locale, referral source, and initial usage patterns. All role assignments and changes are logged with sufficient detail to provide an auditable history. Security measures include schema validation, rate limiting for OTP endpoints, and revocation of tokens when required.

At step 704, the system identifies a set of candidate counterpart users whose profiles satisfy one or more eligibility criteria for the requested interaction. The identification step 704 may use stored match profiles, availability, location data, skills, languages, and other attributes to select candidates that are potentially suitable.

At step 706, for each candidate counterpart user in the identified set, the system computes a compatibility score. The compatibility score is based on attributes of the first user, attributes of the candidate counterpart user, and the context of the requested interaction, and may combine multiple normalized features, such as route and schedule alignment, language and capability match, verification level, and historical reliability, into a single value. At step 708, the system computes risk scores. This includes computing a respective profile risk score for each of the first user and the candidate counterpart user using one or more machine-learned models trained with monotonic constraints, and computing a pairwise risk score for the prospective interaction between the users as a function of at least the corresponding profile risk scores and one or more contextual risk factors.

In some embodiments, the system computes a pairwise risk score for a specific “seeker-provider” combination using their individual risk scores and contextual risk. The pairwise risk R_pair is defined as a combined probability that at least one of the relevant risk factors materialises in the context of this pairing. For example, the system may derive R_pair from the complement of the product of the complements of three terms: the seeker's risk score, the provider's risk score, and a contextual risk factor capturing circumstances such as location, time, route, and service type. This construction ensures that the pairwise risk increases when any of the individual or contextual risks increase, and remains easy to implement and reason about. An example calculation can show that even two individually low-risk users can yield a higher pairwise risk in a high-risk context, such as a sensitive location at a late hour.

In some embodiments, the pairwise risk Rₚₐᵢᵣ(u,p) is computed as:

$${R}_{pair} = 1 - ( ( 1 - {R}_{u} ) \cdot ( 1 - {R}_{p} ) \cdot ( 1 - {R}_{ctx} ) )$$

where Rᵤ, Rₚ: calibrated profile risks, and R_{ctx}: contextual risk in [0,1].

In another example embodiment, the pairwise risk is computed from known inputs. A weighted linear combination of them is formed and then the result is passed through a sigmoid σ(⋅) so the final risk lands between 0 and 1:
a. σ(⋅) is the logistic (sigmoid) function, so R_pair∈(0,1).
b. α0 is a bias (intercept). At −1.5 it pushes the default risk down unless other factors lift it.
c. R_s and R_c are the calibrated profile risk scores for the seeker and the carer (each 0-1). Coefficients α1 and α2 (=1.0 each) say “the higher either user's risk, the higher the pair risk.”
d. |R_s −R_c| with α3=0.5 penalises mismatch—large differences in individual risks nudge pair risk upward (e.g., a very low-risk user with a much higher-risk counterpart).
e. (1−language_overlap) with α4=0.7 raises risk when language overlap is poor (overlap is 0-1, so 1-overlap is the “gap”).
f. (1−skill_fit) with α5=0.6 raises risk when the provider's skills are a poor fit for the request.
g. graph_linkage_score with α6=0.8 raises risk when there are suspicious graph signals (e.g., shared devices, clustered accounts), scaled 0-1.
h. price_mismatch with α7=0.4 raises risk when the quoted price is far from policy/budget expectations (0-1 measure of mismatch).

Accordingly this embodiment calculates as follows:

$$R\_pair = σ ( - 1.5 + 1. \cdot R\_s + 1. \cdot R\_c + 0.5 \cdot \vert R\_s - R\_c \vert + 0.7 \cdot ( 1 - language\_overlap ) + 0.6 \cdot ( 1 - skill\_fit ) + 0.8 \cdot graph\_linkage \_score + 0.4 \cdot price\_mismatch )$$

For example, if R_s=0.12, R_c=0.18, language_overlap=0.9, skill_fit=0.85, graph_linkage_score=0.2, price_mismatch=0.3, then the linear sum is:

$$- 1.5 + 0.12 + 0.18 + 0.5 \cdot 0.06 + 0.7 \cdot 0.1 + 0.6 \cdot 0.15 + 0.8 \cdot 0.2 + 0.4 \cdot 0.3 = - 1.5 + 0.3 + 0.03 + 0.07 + 0.09 + 0.16 + 0.12 = - 0.63$$

σ(−0.63) ≈0.35, i.e., about 35% pairwise risk in this context.

This provides a transparent, monotone, easy-to-compute formula that keeps the same risk drivers as the full model previously described (individual risks, language/skill fit, suspicious links, price issues) and produces a usable probability-like score that does not rely on machine learning.

In another example embodiment, the platform computes a pairwise risk score R_pair(u,pκtx) for a specific seeker-provider combination (u,p) under a context ctx (for example, a late-night handover at a sensitive location). The system uses calibrated profile risk scores Ru and Rp in [0,1] and a context risk Rc in [0,1], and computes R_pair=1−((1−Ru)·(1−Rp)·(1−Rc)). In a low-risk context (Rc=0.05), with Ru=0.12 and Rp=0.18, the pairwise risk is R_pair=1−(0.88·0.82·0.95) ≈0.314. In a higher-risk context (Rc=0.40), with the same low-risk users, the pairwise risk rises to R_pair=1−(0.88·0.82·0.60) ≈0.567. This example demonstrates that context can elevate the pairwise risk into a review or blocked region even when both users individually appear low risk. The function is monotone in each argument so that increases in any of Ru, Rp, or Rc do not produce a decrease in the combined risk.

An automated matching orchestrator, referred to as an orchestration engine, uses the compatibility and risk scores to control match formation. It runs periodically or in response to events such as new listings, status changes, or flight updates. For each candidate pairing, it applies configurable policies and thresholds. If the compatibility score exceeds an automated match threshold and the relevant risk scores are below corresponding limits, it can automatically create a match and notify both parties. If scores satisfy milder conditions, it may generate suggestions for administrative approval, including explanations of the factors considered. If risk or compatibility conditions are not met, it holds or rejects the candidate. The orchestrator exposes endpoints to trigger evaluations, list suggestions, and record approvals or rejections. Administrator actions and their rationales are captured as feedback signals, which may later influence thresholds or models. Safeguards include fairness checks against discriminatory patterns, explainability requirements, override paths, audit logging of decisions, controlled rates of automation, and rollback of matches when post-match risk signals increase.

In some embodiments, the system records configuration and model versions used in automated decisions to allow reconstruction and audit. Each decision record, such as a match selection, risk classification, pricing evaluation, fraud decision, or payout release, includes identifiers of the configuration and model artefacts in effect at the time. These identifiers may include versions for the matching score function and weights, the risk model and calibration parameters, the orchestrator policy thresholds, fraud and referral rules, the internationalisation protocol, and the cryptographic settings. Each version identifier corresponds to a stored configuration or model file with defined metadata, including its checksum and effective start time. By combining the decision record with the referenced configurations, a skilled person can reconstruct how any particular decision was reached under the system as deployed at that time. This mechanism also supports safe evolution of models and policies while preserving traceability.

At step 710, an orchestration engine applies one or more decision policies to the compatibility score, the profile risk scores, and the pairwise risk score, to determine, for each candidate counterpart user, a resulting connection state. The connection state may include, for example, an approved state, a conditional or suggested state, a review state, or a blocked state.

In some embodiments (“example A”), the orchestrator uses S, R_u, R_p, and R_pair with fixed thresholds:
Safe risk: R_u≤0.30, R_p≤0.30, R_pair≤0.35
Medium risk: R_pair∈(0.35, 0.60]
High risk: R_pair >0.60

### Example S Thresholds

S ≥0.75→strong match
0.55≤S<0.75→marginal
S<0.55→not recommended

In this “example A” embodiment, the states are defined as SEARCHING→CANDIDATE LIST→PENDING ACCEPT→MATCHED→IN_PROGRESS→COMPLETED with optional ADMIN_REVIEW and CANCELLED.

### Decision Examples

a. Auto-match:
   If S ≥0.75 and all risk values safe→move directly to MATCHED upon seeker confirmation; notify both parties.
b. Suggest (no auto-match):
   If 0.55<S<0.75 and risk safe→present in candidate list; requires explicit mutual acceptance.
c. Admin review:
   If R_pair medium or R_u/R_p in medium band→send to ADMIN_REVIEW queue with explanation payload; no auto-match.
d. Block:
   If R_pair>0.60 or either profile above high-risk threshold→candidate suppressed; optional silent.
e. Rollback:
   On new adverse signal (chargeback, verified abuse, sudden spike in disputes):
      i. Recompute R_u/R_p/R_pair.
      ii. If threshold crossed for an active MATCHED or IN_PROGRESS booking:
         Transition to secure REVIEW_PENDING state.
         Optionally suspend communication, notify admin, and/or reassign.

At step 712, the system controls the connection and disclosure behaviour in dependence on the selected connection state. In initial or more restrictive states, the system causes only redacted, pseudonymised, or limited user information to be displayed between the parties, while in authorised connection states the system selectively reveals additional identifying information and enables communication capabilities in accordance with configured disclosure policies. In some implementations, the method 700 continues by generating machine-readable decision records capturing the scores, selected connection states, explanations, and configuration versions applied, and by monitoring for new risk-relevant signals that may cause re-evaluation of existing matches and transitions between connection states, although such additional steps are not separately shown in FIG. 7.

Security, privacy, and compliance measures are applied throughout the system. REST and signalling APIs use JWT-based authentication, role-based authorization, and structured input validation. PII redaction layers protect data exposed to AI models and public or semi-public views. WebRTC session descriptions and media-related metadata may be encrypted with ephemeral keys. TURN credentials are rotated and scoped. Wallet and referral transactions are logged with integrity and traceability. Rate limiting and monitoring help to mitigate abuse and denial-of-service risks. Audit logs capture sensitive operations, including administrative actions and configuration changes.

In some embodiments, the system provides an AI-assisted support function driven by a hybrid retrieval mechanism and integrated with the redaction and notification framework. When a user submits a query, the system retrieves candidate documents from a knowledge base using both lexical similarity (for example, BM25 or equivalent) and vector-based similarity, and computes a combined relevance score as a weighted function of both. The system also filters candidates by metadata such as user role, language, airport, route, and booking or case state. The highest-ranked documents are supplied as context to an AI model under a controlled prompt that instructs it to base answers only on the retrieved material, to align with current policies, and to avoid revealing internal thresholds or security details. Before any user content is passed to the AI model, personally identifiable information is replaced using the platform's tokenisation scheme so that the model operates only on pseudonymous identifiers. Upon generating a response, the server replaces tokens with real values only for authorised recipients. Outbound messages and push notifications are labelled with a session identifier and a monotonically increasing sequence number; client applications use this pair as an idempotency key to discard duplicates and restore correct ordering, enabling reliable delivery even when underlying channels retry or reorder messages.

FIG. 8 of the drawings shows an example embodiment of a system 800 implementing the above method and related functionality as an integrated platform. At the highest level, the system 800 comprises client devices 810, an API gateway and signalling server layer 820, a core platform layer 830 including an orchestration engine 840 and multiple supporting services, a data and key management layer 850, and an admin and observability layer 860. Logical connections are indicated between these components to represent authenticated API calls, signalling paths, and internal data flows.

The client devices 810 represent all endpoints through which users interact with the platform. In some embodiments, the client devices 810 include general-purpose mobile and web client applications 811 executed on smartphones, tablets or browsers used by care seekers and carers, specialised handheld terminals 812 issued to escorts or staff with secure elements and restricted software, fixed in-home or clinical assistance terminals 813 deployed in residences or facilities as trusted endpoints, and kiosks or gate-side terminals 814 installed at airports, stations or secure buildings for identity checks and assignment confirmation. Each of the client devices 810 is configured to communicate only with the backend components of the system 800 over authenticated and encrypted channels, such as HTTPS-based REST APIs and secure WebSocket or equivalent signalling connections, and to present device and user credentials issued under platform control.

The core server entry point configures the HTTP server, security middleware, database connections, and real-time signalling server. It mounts all versioned routes under a common path, attaches signalling handlers, and configures webhooks and notification pipelines. This wiring ensures that authentication, authorisation, logging, and observability are consistently applied across subsystems and that signalling and API layers share a unified identity and session model.

In some embodiments, the system architecture comprises a set of coordinated components. An API gateway exposes versioned REST endpoints, applies security middleware such as authentication, authorisation, input validation, rate limiting, logging, and CORS configuration, and forwards requests to internal services.

The API gateway and signalling server layer 820 provides the controlled entry points into the backend. In some embodiments, this layer comprises an API gateway 821 and a signalling server 822. The API gateway 821 terminates TLS connections, validates JSON Web Tokens and device credentials, enforces rate limiting and input validation, performs role-based access control, injects correlation identifiers, and routes incoming API requests from the client devices 810 to appropriate services within the core platform layer 830. The signalling server 822 maintains authenticated, persistent connections to the client devices 810 for real-time communication. It manages mappings between user identifiers and active sockets, handles WebRTC signalling events such as offers, answers, ICE candidates, hangups and reconnects, and delivers real-time events including match updates, state changes, and notifications. The signalling server 822 enforces idempotency and sequence-number rules to prevent duplicate or replayed signalling messages.

A signalling service handles WebRTC offer, answer, ICE candidate, hangup, and disconnect events, maintains mappings of online users to active sockets, and persists call lifecycle records.

The WebRTC signalling subsystem is configured so that each Socket.io or equivalent connection is authenticated by a JWT, ensuring that only registered and authorised users initiate or receive calls. An online user map, optionally backed by a cache such as Redis, maps user identifiers to active connection identifiers. The system defines events for offers, answers, ICE candidates, hangups, and disconnects, and maintains a call record for each interaction. The implementation uses idempotent event handlers with sequence numbers to prevent duplicate processing, persists call state transitions from initiated to ringing, in progress, and ended, and deterministically computes call durations even when network disconnects occur. Sensitive signalling data such as SDP payloads may be encrypted using ephemeral keys derived from authenticated session claims, and TURN server credentials are rotated regularly, bound to limited scopes, and protected in transit.

The platform is designed for scalability and reliability, using shared-nothing patterns and caches where appropriate. Online user tracking, signalling events, and AI support workloads are distributed across multiple instances. Caching strategies and ETag-based negotiation reduce redundant work. Versioned policy engines and feature flags allow safe rollout and rollback of behavioural changes.

The backend software platform described herein supports authenticated in-app WebRTC calling, continuous AI-powered support grounded by a curated knowledge base, route-aware booking validation, multilingual content distribution using internationalisation services with delta updates, secure wallet, transaction and referral handling, promotions and offer management, and a Matchboard marketplace that discovers, ranks, and recommends compatible matches based on multiple signals (the may include, for example, proximity, schedule compatibility, skills, languages, price alignment, trust indicators, verification status, activity, and responsiveness).

Knowledge base management includes ingestion of documents such as PDFs, word processor files, text files, and curated web content into a vector index with versioned namespaces. Retrieval functions perform vector search, fusion between dense and sparse retrieval where appropriate, and contextual truncation to keep inputs within limits. Scheduled processes update, re-index, or replace portions of the knowledge base as content changes, while maintaining compatibility with existing sessions and versioned prompts.

Embodiments of the system may implement, for example, service tiers, verified identities, secure payments, privacy-preserving communication mechanisms, support for popular route discovery, and/or auditable policies with risk-aware automated suggestions and decisions.

Embodiments may include, for example, real-time communication, identity verification, multilingual content delivery, policy-driven transactions, referral and wallet management, and/or auditability.

In example embodiments, the implementation uses JWT-authenticated REST APIs, real-time signalling over technologies such as Socket.io for WebRTC with STUN/TURN integration, vector retrieval over a knowledge base for LLM-based support services, push notifications via services such as Firebase Cloud Messaging, data persistence using MongoDB or equivalent transactional databases for operational logs and wallets, internationalisation services with ETag and delta negotiation for language bundles, and/or integration with third-party verification and payment artifacts.

An ICE servers endpoint provides authenticated clients with up-to-date STUN and TURN configuration, with credentials that are short-lived and constrained to specific uses. This ensures that media relay resources are used only by properly authenticated users and sessions and that misuse can be limited.

The focus is on secure, scalable, privacy-preserving orchestration of interactions between users rather than on isolated frontend features.

The core platform layer 830 includes the orchestration engine 840 and a set of supporting services that collectively implement the decision framework.

A Matchboard marketplace service manages match profiles, listings, scoring, risk evaluation, and orchestrated match suggestions or decisions, using both synchronous endpoints and real-time updates.

The orchestration engine 840 is configured to receive candidate sets and contextual information from the Matchboard service 848 or other components, to request profile risk and pairwise risk evaluations from the Risk Engine 849, to apply configured decision policies over compatibility scores and risk scores, to assign connection states to candidate pairs, and to instruct the Disclosure and Tokenisation service 847 as to what user information may be shown for each connection state. The orchestration engine 840 also emits structured decision records to the data and key management layer 850 and listens for new risk-relevant signals from other services so that existing connections can be re-evaluated, downgraded, paused or terminated where required.

The Matchboard marketplace is a curated matching and recommendation engine that maintains match profiles for users, match listings indicating their availability and visibility, and match records capturing proposed or accepted pairings. A match profile may contain role, availability, home or preferred airports, preferred routes, languages, skills, medical background or capabilities, years of experience, price range, rating, verification status, trust score, live location opt-in, activity indicators, and visibility settings. The system offers endpoints to create and update profiles, search profiles based on filters, obtain personalised recommendations, create match suggestions or requests, and subscribe to real-time matchboard updates.

The matching algorithm combines multiple normalised signals in the range from zero to one, including proximity, schedule and flight overlap, skill match, language match, price compatibility with policy constraints, trust signals derived from verification and ratings, and activity or responsiveness metrics. Weighted sums of these signals produce a compatibility score S that is used to rank candidates.

In some embodiments, the system computes a multi-signal compatibility score S for each candidate provider p given a seeker u as:

$$S ( u , p ) = {\sum }_{i = 1}^{n} {w}_{i} \cdot {f}_{i} ( u , p )$$

where each feature fᵢ is normalized to [0,1] and wᵢ are fixed weights summing to 1.

Tie-breaking strategies prefer higher verification, higher trust, and lower risk. Enhancements include hybrid retrieval techniques for finding relevant profiles, consistent skill taxonomies, intent-aware ranking that considers recent support interactions, and real-time updates via signalling and push notifications. Privacy protections include redaction of personally identifiable information in public listings and staged reveal of more detailed information only when both parties have moved to an accepted or equivalent status. Live location sharing is opt-in and limited to active assistance periods.

The core platform layer 830 further comprises an identity service 841, which manages user accounts, roles and authentication, performs OTP-based login and session management, stores verification outcomes, and supplies user attributes and verification status to the orchestration engine 840. An internationalisation service 842 manages language resources, versioned locale bundles and, in some embodiments, delta updates for translations, allowing client devices 810 to obtain consistent user interface text with reduced bandwidth usage. An AI support service 843 provides AI-assisted support integrated with a knowledge base, using retrieval techniques to construct grounded answers while applying redaction rules from the Disclosure and Tokenisation service 847 so that personal data is not unnecessarily exposed. A WebRTC service 844 manages call sessions established via the signalling server 822, applies signalling security policies, persists call lifecycle information, and enables or disables in-app calling in accordance with connection states determined by the orchestration engine 840.

In some embodiments, an AI support chat subsystem exposes endpoints for starting support sessions, sending messages, and retrieving responses. When a user message is received, the system normalises and classifies the intent, computes one or more embeddings, and retrieves candidate documents or passages from the knowledge base using vector search, optionally combined with lexical search. Retrieved passages are re-ranked based on session context, user role, booking state, and route information. A structured prompt is then constructed for a large language model, constrained to answer based only on provided context and current policies. The resulting answer and the message history are stored, and notifications are delivered to the user's devices through push mechanisms with session and message sequence identifiers that enable deduplication and ordering. To protect privacy, a PII redaction layer sanitises chat content before it is provided to the model and maintains reversible mappings only on the server side so that authorised clients can reconstruct the full information where permitted.

The support chat integrates with a knowledge base using Pinecone-backed retrieval and a strict system prompt that instructs the assistant to answer only from the knowledge base or to return “not available” when suitable grounding cannot be found. Session management creates and maintains chat sessions, stores messages, and sends push notifications, for example via Firebase Cloud Messaging, when AI responses are ready. The proposed PII pipeline performs session-bound tokenisation with a reversible mapping, applies redaction prior to acceptance, reveals underlying values only after acceptance in accordance with Section E, and records an audit trail entry for every reveal or redaction.

In some embodiments the matching weights are [0.20, 0.20, 0.15, 0.10, 0.10, 0.15, 0.10]. Example orchestrator thresholds are S_admin=0.65, R_admin=0.35, S_auto=0.80, and R_auto=0.25. The risk ensemble comprises logistic regression with L2 regularisation together with a LightGBM model configured with monotonic constraints, and the combined outputs are calibrated using isotonic regression. Cryptographic protections use X25519 elliptic-curve Diffie-Hellman for key agreement followed by HKDF-SHA256 to derive keys and AES-256-GCM for authenticated encryption, with nonces constructed to ensure sequence-based uniqueness. Internationalisation employs ETag semantics with delta responses that return only changed or removed keys.

In one example embodiment, the AI support subsystem receives a user query containing personally identifiable information and booking context. The inbound text is normalised and redacted prior to model invocation using session-bound tokens. An illustrative redacted input is: “I, <NAME_TKN 3421>, am meeting my carer at Gate A12 at 21:10. My phone is <TEL_TKN_77>. The app shows ‘Pending Acceptance’—should I wait at Security or proceed to the gate?” The retrieval stage selects policy passages on “Pending Acceptance” behaviour and gate-area handover rules together with a route-specific note for the relevant airport. The model is instructed to answer strictly from retrieved material and not to expose internal thresholds or configuration values. An illustrative server-side answer is: “While your connection is in Pending Acceptance, wait at the designated checkpoint listed in your itinerary. Do not proceed to the sterile area unless instructed. Your carer will confirm arrival via the in-app channel. If the state has not changed after 10 minutes, use the in-app ‘Request Help’ button.” Prior to delivery, tokens are detokenised only for authorised recipients and only to the extent permitted by the current disclosure state. In this example, tokens remain tokenised for the carer until the state transitions to Matched. The response and associated sequence identifiers are persisted so that duplicate deliveries are discarded by clients and a consistent history is retained for audit.

In some embodiments, personally identifiable information is managed according to a defined lifecycle with staged redaction and reveal linked to match states. When a profile or listing is publicly visible, only coarse or pseudonymised data, such as an initial of the first name, general language capabilities, non-specific location, and rating band, is shown. If a user is shortlisted or pre-selected, additional but still limited information may be revealed, such as full first name and aggregate statistics. Upon mutual acceptance of a match, more detailed information can be made available, such as a profile photograph, in-app communication handles, and relevant history, while raw phone numbers and email addresses remain hidden in favour of masked or virtualised contact methods. During an in-progress engagement, real-time communication is facilitated via in-app messaging or voice services without exposing raw contact details. After completion, externally visible data may revert to the coarse level while detailed records are retained only within secured audit logs. The tokenisation process may use a keyed cryptographic function to generate deterministic tokens from PII values combined with user identifiers, with mappings stored in an encrypted vault accessible only to authorised backend components. If any step in a reveal operation fails, the system rolls back to the previous stable state so that no partial or unintended exposure occurs. Logging and analytics systems consume only pseudonymised or aggregated representations, ensuring that raw PII remains confined to tightly controlled subsystems.

In some embodiments, the platform limits and later reveals PII across well-defined workflow states, and how the system replaces raw identifiers with reversible tokens while data is “in transit” or stored in logs.

First, the “States and Field Visibility” section (E.1) defines the connection states, public_listing, requested, accepted, in_progress, completed, and lists which profile fields are visible in each state. Early states show only pseudonymous or masked data (for example, displayName, blurred photo, masked phone such as +XX-XXXX- . . . , masked email such as @d.com, and high-level attributes like languages, skills, years experience, etc). As the state advances to accepted and then in_progress, additional fields are revealed (for example, full first name, full photo, and, where policy allows, finer-grained location during the active assistance window). Some fields are always hidden or only “opt-in” (for example, liveLocation is time-scoped and only visible during active assistance; governmentId is hidden). “Tokenised” in the table means that, until the accepted state is reached, the system substitutes a deterministic token for the raw value in transports and logs; only after acceptance is the actual value revealed to authorised recipients. This gives a concrete, state-by-state disclosure matrix the clients must enforce.

Reversible tokens are constructed and controlled. A token is computed as base64url(HMAC-SHA256(k_session, value)), where k_session is a per-session secret key. That yields a stable token for the same value within the session, but different sessions produce different tokens (so tokens are not usable outside their context). Masking rules are format-preserving for phone and email, so the UI can show familiar hints (e.g., last two digits) without disclosing the full value. The reversal path is server-side only: the mapping from token back to cleartext is stored on the server under a master key (k_master) and tied to the sessionId. The backend will only detokenise when the connection state transitions to accepted (or higher), and only for the authorised party. Every reveal or suppression is written to an audit “Trail” with userId, sessionId, field, operation, state_before, state_after, timestamp, actor, etc. so an auditor can later reconstruct what was shown to whom and when.

In practical terms, this means that before acceptance, listings and messages never carry raw phone numbers, emails, or exact locations; clients and logs see tokens or masked strings. After acceptance, the system may reveal additional fields under policy, and can also re-mask them automatically if the state downgrades (e.g., pause/review). The opt-in live-location means that location sharing is both consent-based and limited to the active service window. Overall, the mechanism enforces least-privilege disclosure, prevents raw PII from leaking via transports and logs, and provides a verifiable audit trail of every reveal event.

In some embodiments, wallet and referral services provide atomic transaction support for credits, debits, referrals, and rewards, including anti-fraud measures and delayed settlement (in travel-related embodiments this may, for example, be based on proof-of-travel).

A payments and wallet service 845 (shown as Payments 845) manages internal balances, payouts, referral rewards, and integrations with payment processors, and generates fraud, chargeback or anomaly events that can be consumed by the Risk Engine 849 and the orchestration engine 840. A booking and pricing service 846 applies route-aware minimum pricing and other policy rules, creates and manages bookings when matches are approved, records which rules were applied, and emits events where pricing or booking patterns indicate elevated risk.

Risk scoring and trust modelling compute a per-profile risk score and, where required, a per-pair risk score used in matching decisions. Signals may include identity verification status and quality, document integrity and liveness results, behavioural indicators such as response latency and cancellation or dispute history, financial signals such as chargebacks and settlement reliability, graph-based signals from shared devices or suspicious account clusters, geospatial inconsistencies, and appropriateness of experience and medical or specialist capabilities for requested tasks. An ensemble model such as logistic regression combined with gradient boosted trees applies monotonic constraints so that improved verification and positive history cannot increase risk, while adverse indicators cannot reduce it. Calibration methods such as Platt scaling or isotonic regression ensure that the resulting risk score lies in a stable range between zero and one. Explanations of key contributing features are stored to support administrative review. The pairwise risk score is computed from the two profiles and contextual factors and is used to decide whether a given combination is acceptable, requires review, or should be suppressed.

The wallet, transaction, and referral subsystem manages internal balances and incentives. Wallet updates are processed atomically and logged with sufficient information to reconstruct each credit or debit, including cause, counterparties, and reference identifiers. Referral mechanisms issue unique referral codes, validate their use, prevent self-referral and certain abuse patterns, and calculate rewards under defined campaigns. Enhanced embodiments implement anti-fraud heuristics based on device identifiers, IP addresses, graph relationships, and behavioural anomalies, and may defer settlement of some rewards or payouts, for example until proof-of-travel or equivalent completion signals are obtained, such as verified check-ins, flight completion confirmations, or recorded service completions.

In some embodiments, the platform optimises internationalisation updates using entity tags and delta transfers. Each set of translations for a particular locale is stored with an associated version identifier, such as a hash-based entity tag derived from the keys and their values. Each key may also be stored with an updated-at timestamp. When a client requests translations, it may include the last known entity tag for that locale. If the tag matches the current version on the server, the server replies that no update is needed. If the tag differs, the server constructs a delta consisting of those keys that have changed since the client's known version, together with any keys that should be removed and the new entity tag and an optional checksum. On receipt of a delta, the client verifies that the base tag corresponds to its current local state, applies the changes deterministically, and updates its stored entity tag. If the base tag does not match, or if checksum validation fails, the client discards the delta and requests the full translation bundle. In the presence of concurrent edits, the server resolves conflicts according to a defined strategy, such as last-write-wins, and the client behaviour remains deterministic because it always either applies a delta tied to its current tag or falls back to a fresh full set. On repeated failures, the client continues to use the last valid bundle and records errors for later diagnosis, ensuring robustness without complex client logic.

In travel-related embodiments, a booking and minimum pricing policy engine integrates with route analysis to distinguish domestic and international journeys and applies pre-defined rules such as minimum fares, geographic thresholds, service-tier-specific pricing, and promotional exceptions. These policies are stored in versioned configurations so that each pricing decision can be traced back to the rule set used at the time. Booking requests are evaluated against these rules before payment processing proceeds, and failure to meet applicable criteria leads to rejection or alternative offers. All evaluations are logged for audit, including the rule version and relevant parameters.

The Disclosure and Tokenisation service 847 maintains, for each defined connection state, a field-level disclosure policy specifying which profile attributes may be displayed to which parties. It performs pseudonymisation or tokenisation of sensitive data such as names, contact details and precise locations using cryptographic techniques and secure storage of mapping information, and ensures that only permitted data is returned to client devices 810 and other services according to the decisions of the orchestration engine 840. The Matchboard service 848 maintains match profiles for users, including availability, preferences, skills and prices, provides search and listing capabilities, and cooperates with the orchestration engine 840 so that candidates are ranked and labelled with appropriate connection states before being presented to users. The Risk Engine 849 executes one or more machine-learned models with monotonic constraints to compute profile risk scores and pairwise risk scores from verification data, behavioural logs, device and network information, financial events and other signals, and exposes these scores to the orchestration engine 840 via a controlled interface.

Table B shows a disclosure policy table. It maps each connection state (public_listing, requested, accepted, in_progress, completed) to the visibility or handling of each profile field, including displayName, profilePhoto, phone, email, liveLocation, and governmentId. The table is the authoritative matrix the system uses to decide whether a field is shown in clear, masked, tokenised, revealed, hidden, or shown only with consent at a given state.

For clarity, the action terms are defined as follows.

Visible means the field is presented in cleartext to the authorised party.
Masked means the field is shown using format-preserving redaction that reveals only minimal hints.
Tokenised means the field is replaced by a reversible token in transports and logs and is detokenised on the server only after the connection reaches the accepted state and only for authorised recipients.
Opt-in means the field is shown only after explicit user consent.
Opt-in (tight scope) means the field, such as liveLocation, is shown only during an active engagement and is constrained by time and geofence limits.

TABLE B
Example Disclosure Policy Table

States and Field Visibility States: ‘public_listing’, ‘requested’, ‘accepted’, ‘in_progress’, ‘completed’.
| Field | public_listing| requested | accepted | in_progress | completed | displayName | psecudonym | pseudonym | real
name | real name| real name ∥|profilePhoto | blurred/thumbnail | thumbnail | full | full | full | phone | masked (‘+XX-
XXXX -_ _ _’) | tokenized | revealed | revealed | masked | email | masked (‘f***@d***.com’) | tokenized | revealed |
revealed | masked | homeAirport | visible | visible | visible | visible | visible | preferredRoutes | visible | visible |
|visible | visible | visible | languages | visible | visible | visible | visible | visible | skills | visible | visible | visible |
visible | visible | yearsExperience | visible | visible | visible | visible | visible | verificationStatus | visible | visible |
visible | visible | visible | liveLocation | hidden | hidden | opt-in | opt-in (tight scope) | hidden | governmentld | hidden |
hidden | masked (last 4, type) | masked | hidden|

The system enforces the table as a state evaluation rule. The client renders only the fields and forms of disclosure that the backend authorises for the current state. If a connection is downgraded to a more restrictive state, any previously revealed fields are re-applied in their masked or tokenised form. Table B defines the field-level disclosure policy enforced by the orchestration engine and by client devices for each connection state.

In some embodiments, the system computes a profile-level risk score R in the range from 0 to 1 for each user account. Training data is drawn from a defined historical window, for example the previous 24 months, and is divided into training, validation, and test subsets. Positive (high-risk) labels are assigned to accounts associated with confirmed fraud, chargebacks, severe complaints, abusive behaviour, or repeated serious policy violations. Negative (low-risk) labels are assigned to accounts with a minimum level of sustained activity and completed jobs without severe incidents. The model may be implemented using gradient boosted decision trees with a defined number of trees and maximum depth. Input features may include identity verification status, document consistency checks, device and IP diversity, historical cancellation and dispute rates, chargeback events, abusive content flags, abnormal booking velocity, time-of-day patterns, and other operational indicators. Monotonic constraints are applied so that the risk score does not increase when evidence of trustworthiness improves, such as additional completed jobs without incident, higher verification levels, or higher ratings, and does not decrease when adverse evidence increases, such as more disputes or chargebacks. The raw model outputs are calibrated to reliable probabilities using a defined calibration method, such as isotonic regression over multiple bins on a validation set, producing a final R value between 0 and 1 that can be directly interpreted and consumed by downstream decision logic.

### Example Embodiment: Risk Model R—Training and Calibration

### Labels and Data Window.

In one example embodiment the risk model uses binary labels in which positive denotes high risk with label=1 and negative denotes low risk with label=0. Negative examples include assistance completed without dispute or chargeback, on-time settlements, absence of identity fraud, and no suspicious graph linkage. Positive examples include the occurrence of a dispute or chargeback, cancellation after acceptance beyond policy thresholds, verification equal to declined, repeated participation in suspicious device or IP clusters, and prior fraud flags. The training corpus covers the most recent eighteen months of events with a rolling monthly refresh, and includes verification artifacts, behavioural metrics, financial events, and graph-derived signals.

### Train, Validation, and Test Split.

In this example embodiment the dataset is partitioned into seventy percent for training, fifteen percent for validation, and fifteen percent for testing, stratified by the binary label. Records are grouped by userId so that all events for a given user reside in the same split to prevent leakage. A time-aware check is applied to ensure that the most recent quarter is represented in the validation and test sets.

### Models and Hyperparameters.

In this example embodiment the system trains an ensemble of models and averages calibrated probabilities from the components. The baseline component is logistic regression with L2 penalty, inverse regularization strength C=1.0, the lbfgs solver, a maximum of two hundred iterations, class weight set to balanced, and z-score feature standardization for continuous features while excluding categorical one-hot indicators from standardization. The second component is a gradient boosted decision tree model with monotonic constraints, for example using LightGBM, configured with num_leaves=31, learning_rate=0.05, n_estimators=500, feature_fraction=0.8, bagging_fraction=0.8, and bagging_freq=1. Monotone constraint vectors are applied to features that must not decrease or must not increase risk as follows: verification equal to verified is constrained to be non-increasing with respect to risk, rating is constrained to be non-increasing with respect to risk, cancellation_count is constrained to be non-decreasing with respect to risk, dispute_count is constrained to be non-decreasing with respect to risk, chargeback_flag is constrained to be non-decreasing with respect to risk, referralTrustScore is constrained to be non-increasing with respect to risk, and identity_confidence is constrained to be non-increasing with respect to risk.

Referring again to FIG. 8 of the drawings, the data and key management layer 850 represents the persistent storage and secure key infrastructure of the system 800. In some embodiments, the layer 850 comprises an operational database 851 storing user profiles, match profiles, bookings, current connection states and other operational records; a decision log store 852 implemented as an append-only or tamper-evident store that records, for each decision made by the orchestration engine 840, the relevant scores, selected connection state, explanation data and configuration or model version identifiers; a risk and events store 853 holding historical signals and normalised events used for training and auditing the risk models executed by the Risk Engine 849; a knowledge base index 854 storing documents and vector embeddings used by the AI support service 843; a translation store 855 holding internationalisation keys, values and version metadata for use by the internationalisation service 842; and a key management or hardware security module component 856 which securely stores tokenisation keys, signing keys, signalling and TURN credentials, and other sensitive cryptographic material.

Access to the key management component 856 is restricted to authorised services such as the orchestration engine 840, the Disclosure and Tokenisation service 847 and the WebRTC service 844. Although not all such subcomponents are explicitly depicted in FIG. 8, they form part of the data and key management functionality indicated by reference numeral 850.

In some embodiments, the platform secures its WebRTC-based communication signalling using authenticated key establishment, encrypted message payloads, and idempotent message sequencing. A client and server or signalling service first perform an elliptic-curve Diffie-Hellman key exchange, such as using X25519, to derive a shared secret. From this shared secret, the system derives one or more encryption keys using a key derivation function, such as HKDF with a defined salt and context string. Session Description Protocol messages and other sensitive signalling data are then encrypted using an authenticated encryption scheme such as AES in Galois/Counter Mode with appropriate key length and unique nonces per message. Each signalling message carries a call identifier, session identifier, sequence number, and type indicator. The server tracks the highest successfully processed sequence number for each call or session and discards messages with duplicate or stale sequence numbers, thereby preventing replay and ensuring idempotency. The server persists sufficient signalling state, such as the most recent offer, answer, and network candidates, to allow recovery after transient disconnections. When a client reconnects, it can resend any unacknowledged messages, and the server can reconstruct the current call state from stored data. Call start time is defined when a call setup or acceptance event is confirmed, and call end time is defined either at an explicit termination event or, in the case of abnormal disconnection, at the last observed media or heartbeat event plus a bounded grace period. The system may issue short-lived TURN and STUN credentials associated with user and call identifiers; these credentials are rotated on a schedule or upon expiry, and invalidated when calls complete or sessions terminate.

In some embodiments, the internationalisation subsystem exposes endpoints to list languages, fetch specific language bundles, fetch all bundles where necessary, and check whether updates are required. It supports ETag headers or equivalent mechanisms to indicate the current version of translation files and can respond with 304 responses when no update is needed. In enhanced embodiments, it calculates and returns only the delta of changed keys since the client's known version, together with metadata indicating new version identifiers and when updates occurred. Push notifications can inform clients that specific languages have been updated so that they can request updated bundles when convenient. This approach reduces bandwidth usage, ensures consistency of UI text across clients, and supports controlled rollout of localisation changes.

The admin and observability layer 860 provides interfaces and tools for governance, configuration and monitoring of the system 800. In some embodiments, the layer 860 includes an admin console 861 that enables authorised personnel to review decision records, inspect explanations of automated decisions, review or approve matches flagged for manual review, and adjust policy parameters such as thresholds and disclosure rules. A model and policy registry 862 stores versioned definitions of compatibility scoring configurations, risk models, orchestration policies, disclosure matrices, pricing rules and fraud detection rules, and supplies version identifiers referenced by the orchestration engine 840 and other services when recording decisions. A monitoring and analytics component 863 aggregates logs, metrics and alerts from across the services, including performance measures, error rates, anomaly indicators and fairness metrics, and supports detection and diagnosis of operational issues. The components of the admin and observability layer 860 interact with the data and key management layer 850 and core platform layer 830 to provide a complete, auditable and tuneable implementation of the decision framework, even though each subcomponent is not separately illustrated at figure scale in FIG. 8.

In some embodiments, the platform implements a wallet, referral, and fraud-control mechanism in which monetary rewards or payouts are released only after proof-of-travel or equivalent completion conditions are satisfied and basic fraud checks are passed. Proof-of-travel may be established by one or more of the following: confirmation from an airline or travel-status interface that a relevant flight has arrived; confirmation that a device associated with a user has entered and remained within a defined geofence around the destination location; or successful completion of an arrival or completion one-time code exchange between the parties. The system evaluates these signals according to deterministic rules; for example, it may release payouts where at least one proof-of-travel condition is satisfied and no active fraud flags are present, and otherwise place payouts on hold. Fraud heuristics may include detection of multiple accounts sharing devices, IP addresses, or payment instruments; unusually high referral density from a small network segment; or rapid sign-up, use, and payout cycles inconsistent with normal usage. Each decision to pay, hold, or block is recorded with a summary of the rules and configuration versions applied, enabling reproducibility and audit.

Together, the elements shown in FIG. 8 define an integrated system 800 in which client devices 810 communicate through the API gateway and signalling server layer 820 to the core platform layer 830. Within the core platform layer 830, the orchestration engine 840 cooperates with specialised services 841 to 849 to compute compatibility scores, risk scores and connection states, and to control staged disclosure of user information. The data and key management layer 850 and admin and observability layer 860 provide persistent storage, cryptographic protection, configuration management and operational oversight that support implementation of the method 700 of FIG. 7 in a concrete, technically robust manner.

In some embodiments, the orchestration service applies explicit thresholds to S, R, and R_pair to control matching behaviour through a defined state machine. For example, users may be classified as safe where their risk scores fall below defined low-risk thresholds, medium where they fall within an intermediate band, and high where they exceed a maximum acceptable threshold. Similarly, S may be divided into strong, marginal, and not-recommended ranges. The system operates over states such as: searching, candidate list, pending acceptance, matched, in progress, completed, admin review, and cancelled. Where S is above a strong threshold and all relevant risk scores are in the safe range, the system can automatically promote a candidate to a matched state upon confirmation by the seeker, without requiring manual intervention. Where S is marginal but risk remains in the safe range, the system may only list the candidate and require explicit acceptance from both parties. Where any profile or pairwise risk is in the medium band, the candidate may be diverted into an administrative review state together with an explanation of the drivers of risk. Where any risk exceeds the high threshold, the candidate may be suppressed altogether. The system periodically or event-wise re-evaluates risk scores upon detection of new signals, such as fresh disputes or fraud indicators, and may transition an existing match from matched or in-progress into a review state, suspend communication, or initiate reassignment according to defined rollback rules.

In some embodiments, the system generates and stores human-readable explanations for matching and risk decisions and uses administrator feedback to refine future behaviour. For each computed compatibility score S, the system records the contribution of each feature as the product of its normalized value and its weight, and identifies the principal positive and negative contributors that led to the final score. For each risk and pairwise risk decision, the system records which signals, such as high dispute rates, incomplete verification, or incident history, contributed materially to the outcome, based on model introspection or explicitly defined rules. For every match decision, an explanation object is stored together with the scores and identifiers. Administrative users reviewing borderline or escalated cases can see these explanations, record an outcome such as confirm, reject, override, or adjust, and those outcomes are logged as labelled events associated with the configuration and model versions. In subsequent system updates, these logs can be used to tune thresholds, retrain models, or adjust policy, while the patent specification describes this as one example of a feedback loop rather than a constraint on operation.

In some embodiments, the system incorporates fairness and governance controls by excluding certain protected characteristics from the features used to compute S, R, and R_pair. Attributes such as gender, ethnicity, religion, and similar protected categories are not used as direct inputs to matching or risk models. These attributes, where available, may be used solely for offline monitoring of system behaviour. The system may periodically evaluate metrics such as the relative rate of auto-matching between different groups defined by protected attributes, and define acceptable ranges for such ratios. If the observed behaviour deviates from these ranges over pre-defined monitoring intervals, the system flags its current configuration and models for human review, possible recalibration, or policy adjustment. This arrangement provides a technically concrete mechanism for monitoring and mitigating unintended bias without limiting the invention to a specific jurisdictional regime.

The solutions described herein provide a tightly integrated stack that combines robust matching, real-time communication, knowledge-aware AI support, route-aware validations, staged information disclosure, auditable wallet and referral flows, and calibrated risk assessment. Many existing systems provide only simple search and listings, ad hoc communication channels, or generic payment processing without end-to-end enforcement of safety, privacy, and auditability policies. In contrast, the backend architecture and functionality described herein address some of these limitations by coordinating multiple subsystems through clearly defined API contracts, stable protocols, structured error handling, and a unified decision framework designed for mobile and web clients.

Error handling and observability are handled using a unified error response format and structured logging for key events such as signalling actions, cache hits and misses, knowledge base retrieval timing, wallet operations, referral validations, and translation updates. Monitoring and alerts detect anomalies such as push notification failures, TURN authentication issues, or degraded external dependencies.

### Example Embodiment: Travel Assistance

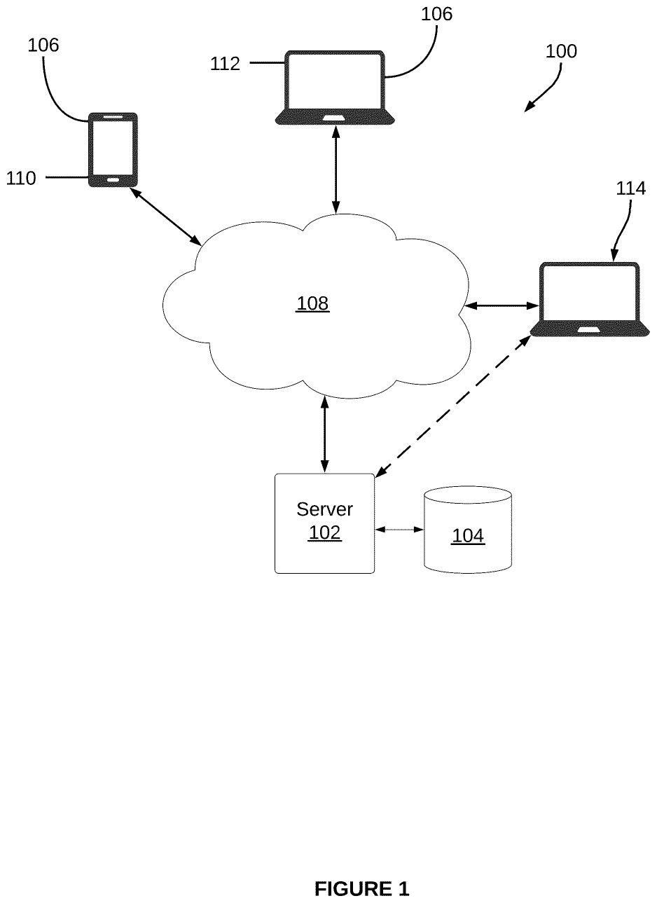

FIG. 1 of the drawings shows an embodiment of a service matching system 100 for matching a service request user and a collocated service provider. The system 100 comprises a matching server 102 with a database 104 of user and service provider data. The system 100 comprises a plurality of client devices 106 in communication with the matching server 102 via a communication network 108.

The platform that connects travellers who need assistance (“care seekers”) with verified travel companions (“carers”) and manages the full journey between them. The system is designed as a secure, auditable, multi-component backend that supports mobile and web clients. It combines identity verification, intelligent matching, risk scoring, in-app calling, AI-assisted support, multilingual content delivery, policy-driven pricing, wallet and referral management, and privacy-preserving data handling in a single coordinated architecture.

In typical operation, a care seeker signs up, verifies their contact details via one-time passcode (OTP), and creates a request describing their route, timing, assistance needs, language preferences, and budget. A carer completes an identity verification process, defines availability, home or preferred airports, skills and experience, languages spoken, and acceptable compensation, and is onboarded as a verified provider. The system exposes selected information about carers and seekers through a “Matchboard” marketplace, performs automatic and semi-automatic matching based on multiple signals, facilitates secure communication and coordination between the parties, enforces pricing and referral policies, and records detailed logs suitable for compliance and technical auditing.

The clients may be in the form of a mobile app on a mobile device 110 or a desktop or web app accessible via a computer 112 such as a laptop. On the landing page of the website or web app, users are able to view the basic information of the platform and the mobile app links for the users. In the mobile app, the user can log in as a service request user (also referred to as a “service requestor” herein), or as a service provider.

When logged in as a service requestor, a user is able to sign up on the platform where the platform will verify their details. Users are able to request a service provider by providing their information including, for example, location requirements, (e.g., flight details), preferred language, preferred gender, etc. and accordingly, they can view the list of service providers that meet the relevant requirements (for example other travellers travelling with the same flight details). The requestor is then able to book a particular service provider and can select a payment method, e.g. via credit card, PayPal, etc.

The client facilitate a connection between the requestor and provider, for example via an in-app messaging facility, or sharing other contact details (e.g., phone numbers, email addresses, etc.).

Users registered as service providers are able to update their availability details, view service requests, and respond to service requests. During service provision, the service provider is able to update the service status, for example indicating location, tasks completed, etc.

Functionality provided by an embodiment of a web site landing page of the web app may be understood with reference to the menu items provided in the app as shown in Table 1.

TABLE 1
Web app menu items

| a) | Content: Users is able to view and check the services (Content) provided/uploaded | |
|---|---|---|
| | by the admin on the platform and users can download the application to their device | |
| | from the respective Play Store and App Store. | |
| | i) | After the successful deployment and publication of the platform on the Play Store |
| | | and App Store, We will provide a QR code that redirects the User to the Play Store |
| | | and App Store. The client can also print the QR code and can use the printed QR |
| | | code as per his/her requirement. |

| | |
|---|---|
| (1) | Scan QR for Android and iOS Applications: Users is able to scan QR codes and there is |
| | two QR codes. |

| | |
|---|---|
| (a) | Scan QR Code (For Android application): On scanning the QR Code, |
| | Users is redirected to the Playstore for downloading Android applications. |
| (b) | Scan QR Code (For iOS application): On scanning the QR Code, |
| | Users is redirected to the App Store for downloading the iOS |
| | application. |

| | |
|---|---|
| ii) | Header: Users is able to view and check the company's header on the top of the website |
| | landing page. |
| iii) | Footer: Users is able to view and check the company's footer on the bottom of the website |
| | landing page. |

| | |
|---|---|
| b) | About Us: Users is able to view the About Us content uploaded by the admin. |
| c) | Privacy Policy: Users is able to view the Privacy Policy content uploaded by the admin. |

Terms and Conditions: Users is able to view the Terms and Conditions content uploaded by the
admin.

Functionality provided by the client app when used in an embodiment of a requestor mode may be understood with reference to the menu items provided in the app as shown in Table 2.

TABLE 2
Example embodiment of requestor client menu items

| | |
|---|---|
| • | Login: Users have to fill in the following details |

| | |
|---|---|
| ∘ | Phone number |
| ∘ | Password |
| ∘ | Note: Users can also log in through social media- Facebook and Google. |

| | |
|---|---|
| • | Forgot Password: Users have the option to reset the account password by clicking on |
| | this forgot password button. An OTP is sent to the email ID for resetting the current |
| | password |
| • | Remember Me: Users have the ability to check on the checkbox present on the screen to allow |
| | the platform to remember the login credentials. |
| • | Book Buddy for Travel: The User is able to book a buddy for the traveling on the platform by |
| | providing details such as |

| | |
|---|---|
| ∘ | Add Flight Details: The user is able to add the flight details such as |

| | |
|---|---|
| ▪ | Current Location |
| ▪ | Flight Date and Time |
| ▪ | Flight Starting/Departure Location |
| ▪ | Flight Destination Location |

| | |
|---|---|
| ∘ | Preferred Language: The user is able to select the preferred language they will |
| | speak and search for a buddy with the same language-speaking person. |

| | |
|---|---|
| ▪ | Language Name |
| ▪ | Language Level |

| | |
|---|---|
| • | Basic |
| • | Medium |
| • | Expert |

| | |
|---|---|
| ∘ | Preferred Buddy Gender: Users have to select the gender of the buddy that they are |
| | looking for on the platform such as |

| | |
|---|---|
| ▪ | Male |
| ▪ | Female |

| | |
|---|---|
| ∘ | Enable Live Location: Users is able to enable their live location so that the Buddy |
| | Service Providers is able to find the User through the |
| | live location. Buddy Service Providers is able to navigate their booked user's live |
| | location. |
| ∘ | Willing to Share their Flight details (Checkbox): Users is able to |
| | enable/disable sharing their flight details with Buddy Service Provider at the |
| | time of booking. |
| ∘ | Search Buddy: On clicking search, the User is able to view the buddy list as per the |
| | selected details above |

| | |
|---|---|
| ▪ | Request details |

| | |
|---|---|
| • | Current Location |
| • | Flight Date and Time |
| • | Flight Starting/Departure Location |
| • | Flight Destination Location |
| • | Selected Preferred Language |
| • | Selected Preferred Buddy Gender |

| | |
|---|---|
| ∘ | Male |
| ∘ | Female |

| | |
|---|---|
| ▪ | Buddy List: Users is able to view the list of buddies as per the above-selected |
| | details as |

| | |
|---|---|
| • | Buddy Profile Image |
| • | Name |
| • | Age |

| | |
|---|---|
| ∘ | Date of Birth |

| | |
|---|---|
| • | Gender |

| | |
|---|---|
| ∘ | Male |
| ∘ | Female |

| | |
|---|---|
| • | Charges to book Buddy: Users is able to view the booking charges |
| | set by the admin. |
| • | Ratings and Review by other users of the platform |
| • | Willing to Share their Flight Details |

| | |
|---|---|
| ∘ | Enabled |
| ∘ | Disabled |

| | |
|---|---|
| • | Availability |

| | |
|---|---|
| ∘ | Busy |
| ∘ | Available |

| | |
|---|---|
| • | Book: Users is able to book the selected buddy from this section. |

| | |
|---|---|
| ∘ | Booking Details: After selecting the buddy available on the platform, users will |
| | proceed further by adding such information as: |

| | |
|---|---|
| ▪ | Payment Method (Add/Delete): The users will view the payment methods |
| | listed on the platform and can select them. |

| | |
|---|---|
| • | Cards: Credit and Debit cards |

| | |
|---|---|
| ∘ | Add New Card: Users is able to add new cards by adding: |
| | ▪ Name |
| | ▪ Card Number |
| | ▪ Exp. Date(MM//YY) |
| | ▪ CVV |
| | ▪ Save |

| | |
|---|---|
| • | Wallet |

| | |
|---|---|
| ▪ | Promo Code: Users can add a promo code if he/she has to enjoy the discount |
| | price for the service. |
| ▪ | Payment Details: Users is able to view payment details with |

| | |
|---|---|
| • | Subtotal |
| • | Buddy Booking Charge |
| • | Discount |
| • | Total Amount |

| | |
|---|---|
| ∘ | Confirm Booking: After confirming a booking, the request is sent to the |
| | nearby select Buddy Service Provider, and the request is forwarded to the |
| | Booking section. Users will get the following details of their request: |

| | |
|---|---|
| ▪ | Request details |

| | |
|---|---|
| • | Current Location |
| • | Flight Date and Time |
| • | Flight Starting/Departure Location |
| • | Flight Destination Location |
| • | Selected Preferred Language |

| | |
|---|---|
| ∘ | Language Name |
| ∘ | Language Level |
| | ▪ Basic |
| | ▪ Medium |
| | ▪ Expert |

| | |
|---|---|
| • | Selected Preferred Buddy Gender |

| | |
|---|---|
| ∘ | Male |
| ∘ | Female |

| | |
|---|---|
| ▪ | Item Total |
| ▪ | Discount |
| ▪ | Total Pay |
| ▪ | Payment Method |
| ▪ | OTP: The User has an OTP shared before starting a service. |
| ▪ | Buddy Service Provider Details |

| | |
|---|---|
| • | Buddy Profile Image |
| • | Name |
| • | Age |

| | |
|---|---|
| ∘ | Date of Birth |

| | |
|---|---|
| • | Gender |

| | |
|---|---|
| ∘ | Male |
| ∘ | Female |

| | |
|---|---|
| • | Ratings |
| • | Call: The user is able to call the buddy service provider directly from |
| | the platform. |

| | |
|---|---|
| ∘ | Note: We will integrate third-party Twilio calling |
| | platform API into the platform, where the call is |
| | placed from the platform using an internet |
| | connection. |

| | |
|---|---|
| • | Chat/Message: The user is able to chat/message with the buddy on |
| | the platform. |

| | |
|---|---|
| ▪ | Cancel: Users is able to cancel the booking at any time with pre-set |
| | cancellation charges Users have to pay. |
| ▪ | Dispute: Users is able to raise a dispute about the service. It is sent to the |
| | admin for the solution. |
| ▪ | Rating: After completion of service, the User will give feedback to the Buddy |
| | Service Provider with the following details: |

| | |
|---|---|
| • | Message for Thank you for Booking |
| • | Total Amount |
| • | Rating with a five-star option |
| • | Describe your Experience |
| • | Submit |

Support chat services integrate with a knowledge base to deliver grounded AI responses and push notifications. Internationalisation services expose endpoints to retrieve translation bundles, check for updates, and negotiate versions with clients.

Functionality provided by the client app when used in another embodiment of a requestor mode may be understood with reference to the menu items provided in the app as shown in Table 3.

TABLE 3
Example embodiment of requestor client menu items

| • | Home Screen: In-home screen Users can view the following information: | |
|---|---|---|
| | ∘ | Book Buddy for Travel: The User is able to book a buddy for the traveling on the |
| | | platform by providing details such as |

| | |
|---|---|
| ▪ | Add Flight Details: The user is able to add the flight details such as |

| | |
|---|---|
| • | Current Location |
| • | Flight Date and Time |
| • | Flight Starting/Departure Location |
| • | Flight Destination Location |
| • | Flight Destination Location |

| | |
|---|---|
| ▪ | Preferred Language: The user is able to select the preferred language |
| | they will speak and search for a buddy with the same language- |
| | speaking person. |

| | |
|---|---|
| • | Language Name |
| • | Language Level |

| | |
|---|---|
| ∘ | Basic |
| ∘ | Medium |
| ∘ | Expert |

| | |
|---|---|
| ▪ | Preferred Buddy Gender: Users have to select the gender of the buddy that |
| | they are looking for on the platform such as |

| | |
|---|---|
| • | Male |
| • | Female |

| | |
|---|---|
| ▪ | Willing to Share their Flight details (Checkbox): Users is able to |
| | enable/disable sharing their flight details with Buddy Service Provider |
| | at the time of booking. |
| ▪ | Search Buddy: On clicking search, the User is able to view the buddy list as |
| | per the selected details above |

| | |
|---|---|
| • | Request details |

| | |
|---|---|
| ∘ | Current Location |
| ∘ | Flight Date and Time |
| ∘ | Flight Starting/Departure Location |
| ∘ | Flight Destination Location |
| ∘ | Selected Preferred Language |
| ∘ | Selected Preferred Buddy Gender |

| | |
|---|---|
| ▪ | Male |
| ▪ | Female |

| | |
|---|---|
| • | Buddy List: Users is able to view the list of buddies as per the above- |
| | selected details as |

| | |
|---|---|
| ∘ | Buddy Profile Image |
| ∘ | Name |
| ∘ | Age |

| | |
|---|---|
| ▪ | Date of Birth |

| | |
|---|---|
| ∘ | Gender |

| | |
|---|---|
| ▪ | Male |
| ▪ | Female |

| | |
|---|---|
| ∘ | Charges to book Buddy |
| ∘ | Ratings and Review by other users of the platform |
| ∘ | Willing to Share their Flight Details |

| | |
|---|---|
| ▪ | Enabled |
| ▪ | Disabled |

| | |
|---|---|
| ∘ | Availability |

| | |
|---|---|
| ▪ | Busy |
| ▪ | Available |

| | |
|---|---|
| ∘ | Book: Users is able to book the selected buddy from this |
| | section. |

| | |
|---|---|
| ▪ | Booking Details: After selecting the buddy available on the platform, users will |
| | proceed further by adding such information as: |

| | |
|---|---|
| • | Add Booking for Parent/Care Taker will have to add the person details |
| | for which the Parent/Care Taker is booking buddy on the platform. |

| | |
|---|---|
| ∘ | My Parents: If the Parent/Care Taker is booking the |
| | buddy service provider for his/her parents then the |
| | Parent/Care Taker will have to add the details such as |

| | |
|---|---|
| ▪ | Name |
| ▪ | Age |
| ▪ | Phone Number |
| ▪ | Number of Passengers |

| | |
|---|---|
| • | 1 |
| • | 2 |
| • | Add details |

| | |
|---|---|
| ∘ | Passenger 1 |

| | |
|---|---|
| □ | Name |
| □ | Age |
| □ | Phone/Mobile Number |

| | |
|---|---|
| ∘ | Passenger 2 |

| | |
|---|---|
| □ | Name |
| □ | Age |
| □ | Phone/Mobile Number |

| | |
|---|---|
| ∘ | Save |

| | |
|---|---|
| • | Payment Method (Add/Delete): The users will view the payment |
| | methods listed on the platform and can select them. |

| | |
|---|---|
| ∘ | Cards: Credit and Debit cards |

| | |
|---|---|
| ▪ | Add New Card: Users is able to add new cards by |
| | adding: |

| | |
|---|---|
| • | Name |
| • | Card Number |
| • | Exp. Date(MM//YY) |
| • | CVV |
| • | Save |

| | |
|---|---|
| ∘ | Wallet |

| | |
|---|---|
| • | Promo Code: Users can add a promo code if he/she has to enjoy the |
| | discount price for the service. |
| • | Payment Details: Users is able to view payment details with |

| | |
|---|---|
| ∘ | Subtotal |
| ∘ | Buddy Booking Charge |
| ∘ | Discount |
| ∘ | Total Amount |

| | |
|---|---|
| • | Chat with Admin: The user is able to chat with the admin from this section of the platform. |

Additional or alternative functionality provided by an embodiment of the client app when used in an embodiment of a requestor mode may be understood with reference to the menu items provided in the app as shown in Table 4

TABLE 4
Example embodiment of requestor client menu items

| • | Check Flight Status: Users is able to track their flight status from this section of | |
|---|---|---|
| | the platform. Users have to add their flight details and accordingly, they can track | |
| | the flight status in real-time. | |
| | ∘ | Note: We will integrate third-party AviationStack Flight-tracking APIs into |
| | | the platform where the client has to pay charges for using third-party Flight- |
| | | tracking APIs if required. |
| • | Booking Management: Users can view the upcoming and latest Bookings listing: | |
| | ∘ | Upcoming Bookings: Users can view the “Bookings”. Users can view the upcoming |
| | | Bookings with details. |
| | ∘ | Past Bookings: The User can view past bookings with the details of a past Buddy |
| | | Service Provider booked on the platform. |

| | |
|---|---|
| ▪ | Booking ID |
| ▪ | Booked By |

| | |
|---|---|
| • | User |

| | |
|---|---|
| ∘ | Profile Image |
| ∘ | Name |
| ∘ | Email |
| ∘ | Phone Number |

| | |
|---|---|
| • | Parent/CareTaker |

| | |
|---|---|
| ∘ | For Parents |

| | |
|---|---|
| ▪ | Total Number of Passengers |
| ▪ | Name |
| ▪ | Age |

| ▪ | Booked with Buddy Service Provider | |
|---|---|---|
| | • | Profile Picture |
| | • | Name |
| ▪ | Flight details | |
| | • | Flight Date and Time |
| | • | Flight Starting/Departure Location |
| | • | Flight Destination Location |

| | |
|---|---|
| ▪ | Selected Preferred Language |

| | |
|---|---|
| • | Language Name |
| • | Language Level |

| | |
|---|---|
| ∘ | Basic |
| ∘ | Medium |
| ∘ | Expert |

| | |
|---|---|
| ▪ | Selected Preferred Buddy Gender |

| | |
|---|---|
| • | Male |
| • | Female |

| | |
|---|---|
| ▪ | Subtotal |
| ▪ | Discount |
| ▪ | Total Pay |
| ▪ | Payment Method |

| | |
|---|---|
| • | Card |

| | |
|---|---|
| ▪ | Status |

| | |
|---|---|
| • | Pending |

| | |
|---|---|
| ∘ | Pickup User (Download Image with User on Pickup Time |
| | uploaded by the Buddy) |

| | |
|---|---|
| ▪ | Entry to Airport |
| ▪ | Check-in Airline Counter |
| ▪ | Immigration Check |
| ▪ | Security Check |
| ▪ | Boarding Gate |
| ▪ | Boarding |
| ▪ | In Flight |

| | |
|---|---|
| ∘ | In Transit |

| | |
|---|---|
| ▪ | Deboarding |
| ▪ | Terminal Change (If Applicable) |
| ▪ | Reaching Boarding Gate |
| ▪ | Boarding |
| ▪ | In Flight |

| | |
|---|---|
| ∘ | Arrival |

| | |
|---|---|
| ▪ | Deboarding |
| ▪ | Immigration |
| ▪ | Baggage Collection |
| ▪ | Customs |
| ▪ | Exit (Download Image with User on Handover user |
| | to receiver time uploaded by the Buddy) |

| | |
|---|---|
| • | Completed |

| | |
|---|---|
| ▪ | Created At |

| | |
|---|---|
| • | Date |
| • | Time |

| | |
|---|---|
| ▪ | Action |

| | |
|---|---|
| • | View |
| • | Delete |

| • | Payment method: Users can view the list of payment methods and add/delete the payment | |
|---|---|---|
| | method. Users can set any payment method as default. | |
| • | Preferred Buddy Service Providers: Users is able to add the Service Provider they want to | |
| | book service in the future. | |
| • | Promo Codes: Users can view Promo codes and can apply them to avail of great discounts on | |
| | their Bookings. | |
| • | Privacy Policy: Users is able to view the Privacy Policy content uploaded by the admin. | |
| • | Terms and Conditions: Users is able to view the Terms and Conditions content uploaded by | |
| | the admin. | |
| • | About Us: Users is able to view the About Us content uploaded by the admin. | |
| • | Notifications: The user is able to get push notifications on the platform as | |
| | ∘ | “Booking Notifications” |

| | |
|---|---|
| ▪ | Service Started |

| | |
|---|---|
| • | Provide updates on check-in, immigration, security, and |
| | boarding processes through color-coded bars (Green for |
| | completed, Red for pending). The Buddy Service Provider is |
| | responsible for updating the status at each stage, triggering |
| | notifications to the User/Attendant. This ensures real-time |
| | communication and smooth progression through each step of the |
| | journey. |

| | |
|---|---|
| ▪ | Service Ended |

| | |
|---|---|
| ∘ | WiFi Connection Notification: The user will automatically receive the WiFi |
| | connection “Name” from their airport location as a push notification upon arriving |
| | at the airport coordinates each time to connect WiFi and can connect to the buddy |
| | service provider. The admin will add the Wifi connection names along with the |
| | location. |
| | (in some embodiments users may receive numerous notifications based on real-time) |
| ∘ | Manage Profile: In the profile, the User can view and edit the image, |
| | name, email ID, phone number, and address. Also, he can change the |
| | password. |

| | |
|---|---|
| ▪ | Note: We will integrate Google Map APIs into the platform where |
| | the address is fetched automatically based on their current location |
| | and the address is automatically shown on the suggestion bar, where the |
| | user can add the address. |

| | |
|---|---|
| ∘ | Payment Method: Users can view/edit/delete the added payment method. |
| ∘ | Help & Support: If the User has any other queries, he can click on the “Send A |
| | Message” button and fill out the form by “Enter Name, Message, and Submit |
| | Button”. This query will get submitted to the support system, and they will |
| | respond to the User promptly. |
| ∘ | Logout |

Functionality provided by the client app when used in an embodiment of a service provider mode may be understood with reference to the menu items provided in the app as shown in Table 5.

TABLE 5
Service provider client menu items

| • | Login: Buddy Service Providers will have to fill in the following details | |
|---|---|---|
| | ∘ | Phone number |
| | ∘ | Password |
| • | Forgot Password: Buddy Service Providers will have the option to reset the account | |
| | password by clicking on this forgot password button. An OTP is sent to the email ID for | |
| | resetting the current password | |
| • | Remember Me: Buddy Service Providers will have the ability to check on the | |
| | checkbox present on the screen to allow the platform to remember the login | |
| | credentials. | |
| • | Manage Availability: Buddy Service Providers is able to manage their availability from this | |
| | section | |
| | ∘ | Manage Availability: Buddy Service Providers can manage their availability from |
| | | here. |

| | |
|---|---|
| ▪ | Availability |

| | |
|---|---|
| • | ON |
| • | OFF |

| | |
|---|---|
| ∘ | Enable Live Location: Buddy Service providers is able to enable the live location |
| | so that the users is able to find the Buddy through the |
| | live location. Users is able to navigate their buddy's live location. |
| ∘ | Willing to Share their Flight details (Checkbox): Buddy Service providers is |
| | able to enable/disable sharing their flight details with the User at the time of |
| | booking. |

| | |
|---|---|
| ▪ | Enable |
| ▪ | Disable |

| | |
|---|---|
| ∘ | Add Flight details: Buddy Service Providers will have to add flight details in |
| | which they are going and accordingly the users is able to search for them on the |
| | platform |

| | |
|---|---|
| ▪ | Add Flight Date and Time |
| ▪ | Add Flight Starting/Departure Location |
| ▪ | Add Flight Destination Location |
| ▪ | Submit |

| | |
|---|---|
| ∘ | Add Language Preference: Buddy Service Provider will have to add their |
| | language preference for the users to search them easily as per their |
| | choice/availability on the platform |

| | |
|---|---|
| ▪ | Add Language Name |
| ▪ | Add Language Level |

| | |
|---|---|
| • | Basic |
| • | Medium |
| • | Expert |

| | |
|---|---|
| ▪ | Submit |

| | ∘ | Save Details: On Clicking Save, Buddy Service Providers is able to post the updated |
|---|---|---|
| | | details for the Users to book them on the platform. |
| • | Booking Requests: The Buddy Service Providers will receive the booking request from the | |
| | users and can view the following details: | |
| | ∘ | Request details |

| | |
|---|---|
| ▪ | User Current Location |
| ▪ | User details |

| | |
|---|---|
| • | Profile Image |
| • | Name |

| | |
|---|---|
| ▪ | Flight Date and Time |
| ▪ | Flight Starting/Departure Location |
| ▪ | Flight Destination Location |
| ▪ | Selected Preferred Language |
| ▪ | Selected Preferred Buddy Gender |

| | |
|---|---|
| • | Male |
| • | Female |

| | |
|---|---|
| ▪ | Willing to Share Flight details |

| | |
|---|---|
| • | Yes |
| • | No |

| | |
|---|---|
| ▪ | Item Total |
| ▪ | Discount |
| ▪ | Total Pay |
| ▪ | Payment Method |
| ▪ | Accept/Reject |

| | |
|---|---|
| ∘ | Booking Details: After Selecting the Accept button, the Buddy Service Provider |
| | will move on to Booking details and the buddy service provider is able to view: |

| | |
|---|---|
| ▪ | Booking Details |

| | |
|---|---|
| • | Booked By |

| | |
|---|---|
| ∘ | User |

| | |
|---|---|
| ▪ | Profile Image |
| ▪ | Name |

| | |
|---|---|
| ∘ | Parent/Care Taker |

| | |
|---|---|
| ▪ | For Parents |
| | • Total Number of Passengers |
| | • Name |
| | • Age |

| | |
|---|---|
| • | Flight details |

| | |
|---|---|
| ∘ | Flight Date and Time |
| ∘ | Flight Starting/Departure Location |
| ∘ | Flight Destination Location |

| | |
|---|---|
| • | Selected Preferred Language |

| | |
|---|---|
| ∘ | Language Name |
| ∘ | Language Level |

| | |
|---|---|
| ▪ | Basic |
| ▪ | Medium |
| ▪ | Expert |

| | |
|---|---|
| • | Selected Preferred Buddy Gender |

| | |
|---|---|
| ∘ | Male |
| ∘ | Female |

| | |
|---|---|
| ▪ | Subtotal |
| ▪ | Discount |
| ▪ | Total Pay |
| ▪ | Payment Method |
| ▪ | Communicate with User: Buddy Service Provider is able to communicate |
| | with users on the platform from this section. |

| | |
|---|---|
| • | Call: The buddy service provider is able to call the user directly from |
| | the platform. |

| | |
|---|---|
| ∘ | Note: We will integrate third-party Twilio calling |
| | platform API into the platform, where the call is |
| | placed from the platform using an internet |
| | connection. |

| | |
|---|---|
| • | Chat/Message: The buddy service provider is able to chat/message |
| | with the user on the platform. |

| | |
|---|---|
| ▪ | Pickup User: Once the Buddy Service Provider picks up the user, the buddy is |
| | able to update the status of the booking as |

| | |
|---|---|
| • | Entry to Airport: Once the buddy enters the airport, he/she meets the |
| | user and security clearance for entry (Ticket, Passport). |

| | |
|---|---|
| ∘ | Add Picture with User |

| | |
|---|---|
| ▪ | Submit |

| | |
|---|---|
| • | Check-in Airline Counter: On clearing the entrance, they |
| | is forwarded to check-in (documents), luggage drops, and |
| | proceed to immigration (wheelchair and luggage). |
| • | Immigration Check: On completing the airline counter |
| | check-in, the buddy and user is forwarded to the immigration |
| | check where the user/buddy will proceed to security |
| | (wheelchair and luggage). |
| • | Security Check: After the immigration check, they is |
| | forwarded to the security check section where they will give |
| | their luggage to the security belt and proceed to board |
| | (Wheelchair and luggage). |
| • | Boarding Gate: On completing the security check, the buddy |
| | and user will proceed to the boarding gate, where they will take |
| | a break and can have food as per their choice. |
| • | Boarding: After the break at the boarding gate, both is |
| | boarding to plane including the boarding pass and they will |
| | proceed to the flight with (Wheelchair (if taken) and luggage). |
| • | In Flight: After boarding and proceeding to the flight, both will |
| | find the seat, store luggage, and communicate with airline staff |
| | including any errands example food, beverage order assistance, |
| | extra blankets, toilet assistance, and medical needs or |
| | assistance. |

| | |
|---|---|
| ▪ | In Transit: On updating the In Transit status of the booking they will proceed |
| | on this section and |

| | |
|---|---|
| • | Deboarding: After changing the booking status in Transit, both can |
| | de-plane the aircraft and luggage assistance. |
| • | Terminal Change (If Applicable): If the user and buddy |
| | have to change their terminal they have to change the |
| | terminals in their flight. After that, they both will travel to the |
| | terminal. |
| • | Reaching Boarding Gate: On completing the terminal change, |
| | the buddy and user will proceed to the boarding gate, where |
| | they will take a break and can have food as per their choice. |
| • | Boarding: After the break at the boarding gate, both is |
| | boarding to plane including the boarding pass and they will |
| | proceed to the flight with (Wheelchair (if taken) and luggage). |
| • | In Flight: After boarding and proceeding to the flight, both will |
| | find the seat, store luggage, and communicate with airline staff |
| | including any errands example food, beverage order assistance, |
| | extra blankets, toilet assistance, and medical needs or |
| | assistance. |

| | |
|---|---|
| ▪ | Arrival: On arriving at the destination process, both will arrive at |
| | the destination and the Buddy Service Provider will update the |
| | status accordingly onto the platform as given below |

| | |
|---|---|
| • | Deboarding: After reaching the destination, both can de-plane the |
| | aircraft and proceed to luggage assistance and toilet break on the way. |
| • | Immigration: On reaching the destination, the buddy and |
| | user is forwarded to the immigration check-in, and both |
| | proceed to the luggage belt. |
| • | Baggage Collection: On the last steps of the booking, both will |
| | collect luggage and ident and offload from the belt on the trolly |
| | and they will proceed to customs. |
| • | Customs: On the last step of the flight from the customs |
| | section, both will assist with User queries, and luggage |
| | assistance if the customs request for inspection. After both will |
| | proceed to exit. |
| • | Exit: At the end of the booking, the buddy will hand over the user to |
| | the receiver and arrange a phone call/ taxi or transport. |

| | |
|---|---|
| ∘ | Add a Picture of handovering the User to the Receiver |

| | |
|---|---|
| ▪ | Submit |

| | |
|---|---|
| ▪ | End of Service/Complete: After completing the service, Buddy Service |
| | Providers will have a button on the screen, i.e. “Complete”. After |
| | clicking on the Complete button, the Buddy Service Providers will get a pop on |
| | the screen for ratings to the User. |
| ▪ | Ratings: After completing the booking, the Buddy Service Providers will give |
| | feedback to the user with the following details: |

| | |
|---|---|
| • | Message for Thank your booking |
| • | Total Amount |
| • | Rating with a 5-Star Option |
| • | Feedback |
| • | Submit |

| • | Earning: The Buddy Service Providers can view the weekly earnings. | |
|---|---|---|
| ∘ | Week Earning: In week earning, a Buddy Service Provider can view the total | |
| | amount he earned in a week with completed, Accepted, Rejected, and canceled | |
| | services on a weekly basis. | |
| ∘ | History: The Buddy Service Provider can view the previous booking history listing with details | |
| | such as | |
| | ▪ | Booked By |

| | |
|---|---|
| • | User |

| | |
|---|---|
| ∘ | Profile Image |
| ∘ | Name |

| | |
|---|---|
| • | Parent/CareTaker |

| | |
|---|---|
| ∘ | For Parents |

| | |
|---|---|
| ▪ | Total Number of Passengers |
| ▪ | Name |
| ▪ | Age |

| | |
|---|---|
| ▪ | Flight details |

| | |
|---|---|
| • | Flight Date and Time |
| • | Flight Starting/Departure Location |
| • | Flight Destination Location |

| | |
|---|---|
| ▪ | Selected Preferred Language |

| | |
|---|---|
| • | Language Name |
| • | Language Level |

| | |
|---|---|
| ∘ | Basic |
| ∘ | Medium |
| ∘ | Expert |

| | |
|---|---|
| ▪ | Selected Preferred Buddy Gender |

| | |
|---|---|
| • | Male |
| • | Female |

| | |
|---|---|
| ▪ | Subtotal |
| ▪ | Discount |
| ▪ | Total Pay |
| ▪ | Payment Method |

| | |
|---|---|
| • | Card |

| | |
|---|---|
| ▪ | Status |

| | |
|---|---|
| • | Pending |

| | |
|---|---|
| ∘ | Pickup User (Download Image with User on Pickup Time uploaded |
| | by the Buddy) |

| | |
|---|---|
| ▪ | Entry to Airport |
| ▪ | Check-in Airline Counter |
| ▪ | Immigration Check |
| ▪ | Security Check |
| ▪ | Boarding Gate |
| ▪ | Boarding |
| ▪ | In Flight |

| | |
|---|---|
| ∘ | In Transit |

| | |
|---|---|
| ▪ | Deboarding |
| ▪ | Terminal Change (If Applicable) |
| ▪ | Reaching Boarding Gate |
| ▪ | Boarding |
| ▪ | In Flight |

| | |
|---|---|
| ∘ | Arrival |

| | |
|---|---|
| ▪ | Deboarding |
| ▪ | Immigration |
| ▪ | Baggage Collection |
| ▪ | Customs |
| ▪ | Exit (Download Image with User on Handover user to |
| | receiver time uploaded by the Buddy) |

| | |
|---|---|
| • | Completed |

| | |
|---|---|
| ▪ | Created At |

| | |
|---|---|
| • | Date |
| • | Time |

| | |
|---|---|
| ▪ | Action |

| | |
|---|---|
| • | View |

| • | Wallet: Buddy Service Provider is able to receive the earnings from the admin on their wallet | |
|---|---|---|
| | and withdraw them into the bank account. | |
| • | Bank Account Payment Details: The Buddy Service Providers can add & view the payment | |
| | details like: | |
| | ∘ | Routing Number |
| | ∘ | Account Number |
| | ∘ | Account Holder Name |
| | ∘ | Bank Name |
| • | Privacy Policy: Buddy Service Providers is able to view the Privacy Policy content uploaded by | |
| | the admin. | |
| • | Terms and Conditions: Buddy Service Providers is able to view the Terms and Conditions | |
| | content uploaded by the admin. | |
| • | About Us: Buddy Service Providers is able to view the About Us content uploaded by the | |
| | admin. | |
| • | Help & Support: If the Buddy Service Providers have any other queries, they can | |
| | click on the “Send A Message” button and fill out the form by “Enter Name, Message, | |
| | and Submit Button”. This query will get submitted to the support system, and they will | |
| | respond to the Service Providers promptly. | |
| • | Notifications: Buddy Service Providers is able to get push notifications on the platform as | |
| | ∘ | “Booking Notifications” |

| | |
|---|---|
| ▪ | New Booking Request Received |

| | ∘ | Wifi Connection Notification: The Buddy Service Providers will automatically |
|---|---|---|
| | | receive the WiFi connection “Name” from their airport location as a push |
| | | notification upon arriving at the airport coordinates each time to connect wifi and |
| | | can connect to the buddy service provider. The admin will add the WiFi |
| | | connection names along with the location. |
| | ∘ | Note: In this section, Buddy Service Providers will receive numerous notifications based |
| | | on real-time. There are no restrictions on push notifications |
| • | Manage Profile: Buddy Service Providers is able to manage profiles from this section as: | |
| | ∘ | View and Edit Profile |
| | ∘ | Change Password |

| | |
|---|---|
| • | Logout |

Some embodiments may include an administrator client, for example accessed via an administrator device 114 in communication with the server 102 and/or the client devices 106 via the communication network 108. The administrator device 114 may be in direct communication with the server 102. The administrator client may be provided in the form of a mobile app, a web app, or the like.

Functionality provided by the administrator client may be understood with reference to the menu items provided in the app as shown in Table 6:

TABLE 6
Administrator client menu items

| 1. | Login: Admin is able to log in using the credentials (Email address & password) | |
|---|---|---|
| | provided by us. | |
| | a. | Email address |
| | b. | Password |
| 2. | Forgot password: Admin is able to use this option to recover/reset their account | |
| | password if they forget it. | |
| | a. | Email address: Admin provides their registered email address. A password reset |
| | | link is sent to the email. |
| 3. | Dashboard: On the dashboard, Admin is able to review the following things | |
| | a. | The admin can update his profile |
| | b. | The admin sees the admin ID |
| | c. | The admin can see the drop-down and from there he can access the profile, |
| | | password, and logout. |
| | d | Total number of Bookings Completed by Users |
| | e. | Total revenue for the last seven days |
| | f. | Details of new Buddy Service Providers registered and their details. |
| | g. | The admin can see the total bookings completed through the chart. |
| 4. | Manage Users: This tab shows all the User information. Admin can view the | |
| | listing of Users with name, email, mobile registered time, and action button. | |
| | a. | By clicking on the action button, the admin can perform the “edit, delete and view” |
| | | function. |
| | b. | User Listing: The admin is able to view the list of Users on the platform with |
| | | details such as |

| | |
|---|---|
| i. | User Personal details |

| | |
|---|---|
| 1. | Profile Image |
| 2. | Full Name |
| 3. | Email ID |
| 4. | Mobile number with country code |
| 5. | Age |
| 6. | DOB |

| | |
|---|---|
| a. | DD/MM/YYYY |

| | |
|---|---|
| 7. | Gender |

| | |
|---|---|
| a. | Male |
| b. | Female |

| | |
|---|---|
| ii. | Uploaded Documents |

| | |
|---|---|
| 1. | Upload ID Photo and Address Proof |

| | |
|---|---|
| iii. | Medical Issue |

| | |
|---|---|
| 1. | Yes |
| 2. | No |

| | |
|---|---|
| iv. | Created At |

| | |
|---|---|
| 1. | Date |
| 2. | Time |

| | |
|---|---|
| v. | Action |

| | |
|---|---|
| 1. | View |

| | |
|---|---|
| a. | Block/Unblock |

| | |
|---|---|
| 2. | Delete |

| | |
|---|---|
| c. | The admin can filter by status: |

| | |
|---|---|
| vi. | All: View all the User details |
| vii. | Active: View all the active Users |
| viii. | Inactive: View all the active Users |
| ix. | The admin can search based on name, and email. |
| x. | The admin can find new Users. |
| xi. | The admin can export or import the data through CSV format. |

| 5. | Manage Service Providers: This tab shows all the Service Provider's information. | |
|---|---|---|
| | Admin can view Buddy Service Providers details with name, email, and mobile | |
| | registered time and can assign requests to Service Providers on the platform by itself. | |
| | The admin can perform the “edit, delete, and view” function by clicking on the action | |
| | button. | |
| | a. | Buddy Service Provider Listing: The admin is able to view the list of Buddy Service |
| | | Providers on the platform with details such as |

| | |
|---|---|
| i. | Buddy Service Provider Personal details |

| | |
|---|---|
| 1. | Profile Image |
| 2. | Full Name |
| 3. | Email ID |
| 4. | Mobile number with country code |
| 5. | Age |
| 6. | DOB |

| | |
|---|---|
| a. | DD/MM/YYYY |

| | |
|---|---|
| 7. | Gender |

| | |
|---|---|
| a. | Male |
| b. | Female |

| | |
|---|---|
| ii. | Uploaded Documents |

| | |
|---|---|
| 1. | Upload ID Photo and Address Proof |

| | |
|---|---|
| iii. | Created At |

| | |
|---|---|
| 1. | Date |
| 2. | Time |

| | |
|---|---|
| iv. | Action |

| | |
|---|---|
| 1. | View |

| | |
|---|---|
| a. | Block/Unblock |

| | |
|---|---|
| 2. | Delete |

| | |
|---|---|
| b. | The admin can filter by status: |

| | |
|---|---|
| i. | All: View all Buddy Service Provider details |
| ii. | New: View only new Buddy Service Provider detail records |
| iii. | The admin can export or import the data through CSV format. |

| 6. | Manage Bookings: Admin is able to view and manage the bookings with filter and search. | |
|---|---|---|
| | a. | Filter: Admin can apply the following filters while browsing bookings |

| | |
|---|---|
| i. | Status |

| | |
|---|---|
| 1. | Pending/Ongoing |
| 2. | Completed |

| | |
|---|---|
| b. | Search: Admin is able to search booking details from the search bar |
| c. | Booking Listing: Admin is able to view the list of bookings with the following |
| | information |

| | |
|---|---|
| i. | Booking ID |
| ii. | Booked By |

| | |
|---|---|
| 1. | User |

| | |
|---|---|
| a. | Profile Image |
| b. | Name |
| c. | Email |
| d. | Phone Number |

| | |
|---|---|
| 2. | Parent/CareTaker |

| | |
|---|---|
| a. | For Parents |

| | |
|---|---|
| i. | Total Number of Passengers |
| ii. | Name |
| iii. | Age |
| iv. | Mobile/Phone Number |

| | |
|---|---|
| iii. | Booked with Buddy Service Provider |

| | |
|---|---|
| 1. | Name |
| 2. | Email |
| 3. | Phone Number |

| | |
|---|---|
| iv. | Flight details |

| | |
|---|---|
| 1. | Flight Date and Time |
| 2. | Flight Starting/Departure Location |
| 3. | Flight Destination Location |

| | |
|---|---|
| v. | Selected Preferred Language |

| | |
|---|---|
| 1. | Language Name |
| 2. | Language Level |

| | |
|---|---|
| a. | Basic |
| b. | Medium |
| c. | Expert |

| | |
|---|---|
| vi. | Selected Preferred Buddy Gender |

| | |
|---|---|
| 1. | Male |
| 2. | Female |

| | |
|---|---|
| vii. | Subtotal |
| viii. | Discount |
| ix. | Total Pay |
| x. | Payment Method |

| | |
|---|---|
| 1. | Card |

| | |
|---|---|
| xi. | Status |

| | |
|---|---|
| 1. | Pending |

| | |
|---|---|
| a. | Pickup User (Download Image with User on Pickup Time |
| | uploaded by the Buddy) |

| | |
|---|---|
| i. | Entry to Airport |
| ii. | Check-in Airline Counter |
| iii. | Immigration Check |
| iv. | Security Check |
| v. | Boarding Gate |
| vi. | Boarding |
| vii. | In Flight |

| | |
|---|---|
| b. | In Transit |

| | |
|---|---|
| i. | Deboarding |
| ii. | Terminal Change (If Applicable) |
| iii. | Reaching Boarding Gate |
| iv. | Boarding |
| v. | In Flight |

| | |
|---|---|
| c. | Arrival |

| | |
|---|---|
| i. | Deboarding |
| ii. | Immigration |
| iii. | Baggage Collection |
| iv. | Customs |
| v. | Exit (Download Image with User on Handover |

user to receiver time uploaded by the Buddy)

| | |
|---|---|
| 2. | Completed |

| | |
|---|---|
| xii. | Created At |

| | |
|---|---|
| 1. | Date |
| 2. | Time |

| | |
|---|---|
| xiii. | Action: The admin is able to perform such actions on the selected booking. |

| | |
|---|---|
| 1. | View |
| 2. | Delete |

| 7. | Earnings: The admin is able to manage and check the earnings from this section. | |
|---|---|---|
| | Admin is able to manage the commission they receive on each transaction. | |
| | a. | Set Buddy Service Charges: The admin is able to set the buddy service charges that |
| | | the user have to pay on the platform. |
| | b. | Set Service Booking Charges: The Admin is able to set the service |
| | | booking charges for the user to book the buddy service provider on the |
| | | platform. |
| 8. | Pay to Buddy Service Provider: The Admin is able to payout the buddy service | |
| | providers' earnings to them manually through this section of the platform. | |
| 9. | Manage Dispute: Admin can view and resolve disputes raised by Users for bookings they | |
| | have taken through the application. | |
| | a. | Dispute listing |
| | b. | Dispute details |

| | |
|---|---|
| i. | User name |
| ii. | Buddy Service Provider name |
| iii. | Dispute amount |
| iv. | Refund amount |
| v. | Status |
| vi. | Dispute raising date |

| 10. | Manage Wifi Connection Name: Admin is able to manage the wifi | |
|---|---|---|
| | connections of the airports from this section where users get push | |
| | notifications upon reaching the airport every time to connect wifi and can connect to | |
| | the buddy service provider. | |
| | a. | Wifi Connection Name Listing: Admin is able to view and manage the wifi |
| | | connection name listed on the platform with details such as |

| | |
|---|---|
| i. | Wifi Connection Name |
| ii. | Location |

| | |
|---|---|
| 1. | Location GPS Coordinates |

| | |
|---|---|
| iii. | Created At |

| | |
|---|---|
| 1. | Date |
| 2. | Time |

| | |
|---|---|
| iv. | Action |

| | |
|---|---|
| 1. | View |
| 2. | Delete |
| 3. | Edit |

| | |
|---|---|
| b. | Add Wifi Connection Name Listing: The admin is able to add the Wifi |
| | Connection Name for users to connect wifi and can connect to the |
| | buddy service provider by providing details such as |

| | |
|---|---|
| i. | Add Wifi Connection Name |
| ii. | Add Location |

| | |
|---|---|
| 1. | Add Location GPS Coordinates |

| | |
|---|---|
| iii. | Save |

| 11. | Chat with User: The admin is able to chat with the user from this section of the platform. | |
|---|---|---|
| 12. | Promo Codes: The Admin is able to add, delete, and update promo code time durations | |
| | from this section. | |
| 13. | Reports: The admin is able to see the reports per booking and user. | |
| | a. | Booking: Report for booking and revenue by selecting a custom date range. |
| | b. | User: Report for Users selecting a custom date range |
| 14. | Notification: The admin is able to send mass textual-based notifications to the Users and | |
| | Buddy Service Providers of the platform. | |
| 15. | Accounting: The admin can check any transactions by selecting a date range. This | |
| | includes all transactions, including commissions, and all for Buddy Service | |
| | Providers. The admin can export the sheet in CSV format. | |
| | a. | Admin Transactions: Check the following details by selecting a custom date range |

| | |
|---|---|
| i. | Time |
| ii. | Type |
| iii. | Amount |
| iv. | Earning |
| v. | Description |
| vi. | Action |

| | |
|---|---|
| b. | Withdrawal transaction: The admin can check any withdrawal |
| | transactions by selecting a date range. The admin can export the sheet |
| | in CSV format. Admin can check the following details by selecting a |
| | custom date range |

| | |
|---|---|
| i. | Time |
| ii. | Type |
| iii. | Amount |
| iv. | Earning |
| v. | Description |
| vi. | Action |

| 16. | System Access: The admin can create the sub-admins and can define their roles. The roles | |
|---|---|---|
| | can be multiple based on the admin's requirement | |
| | a. | Sub-admin: Admin can define multiple sub-admins. |
| | b. | Roles: Admin can define multiple roles as per his choice. |
| 17. | FAQ management: Admin is able to manage all the questions on the FAQ page from this | |
| | section. | |
| | a. | Add FAQ: Admin is able to add new questions to the FAQ section. |

| | |
|---|---|
| i. | Question Title |
| ii. | Answer |

| | |
|---|---|
| b. | FAQ listing: admin is able to view a list of all the existing questions. |
| c. | Edit FAQ question |
| d. | Delete question |

| | |
|---|---|
| 18. | Content Page management: Admin is able to manage the content on all the content-based |
| | pages listed below. |

| | |
|---|---|
| a. | Content pages: |

| | |
|---|---|
| i. | Privacy policy |
| ii. | Terms & Conditions |
| iii. | About us |

| | |
|---|---|
| b. | Edit page content |

| | |
|---|---|
| i. | Title |
| ii. | Description |

| 19. | Settings: Admin is able to manage general settings like | |
|---|---|---|
| | a. | Profile Image |
| | b. | Change Password |

| | |
|---|---|
| 20. | Logout |

For hosting a server to support mobile apps, suitable hardware may include high-performance machines with multi-core processors, enough RAM, and SSD storage. For example, a server with t a quad-core CPU, 16 GB or more of RAM, and SSDs ensures quick data access and efficient processing of concurrent client requests. For a server expected to handle high traffic, scalable infrastructure like cloud-based solutions (e.g., AWS EC2, Google Cloud Compute Engine) can dynamically allocate resources as demand fluctuates. These cloud services also offer load balancing and redundancy to prevent downtime. For on-premises setups, using dedicated servers with redundant power supplies, network interfaces, and RAID-configured storage can enhance reliability and data integrity, making them well-suited for production environments that require stability and high availability.

The matching server 102, functioning within a client-server architecture, can be implemented by selecting a suitable technology stack, which may include programming languages such as Python, JavaScript, Java, or PHP, along with frameworks like Django, Flask, Express.js, or Spring Boot. The server 102 is responsible for handling requests from the client(s) 106, processing data, and returning responses. The server environment may be configured, either locally for development or on cloud platforms like AWS, Google Cloud, or Azure for production deployment. The server setup involves creating API endpoints that allow mobile clients to interact with various backend functionalities, such as user authentication, data retrieval, and form submissions. These endpoints may be implemented using RESTful principles or, alternatively, GraphQL for more flexible data queries. A Stripe API is included to support online payment and related e-commerce transactions.

To ensure data persistence and scalability, the server integrates with one or more databases 104, either relational (such as MySQL or PostgreSQL) or NoSQL (like MongoDB or Firebase). Incorporating an ORM tool, such as Sequelize for JavaScript or SQLAlchemy for Python, can streamline database interactions. Security may be implemented using JSON Web Tokens (JWT) for user authentication, HTTPS for secure communication, and/or CORS to control cross-origin requests is critical. In some embodiments, the server 102 may also benefit from real-time monitoring and logging solutions to track performance, detect errors, and ensure system stability.

In some embodiments, the client-server architecture used may include containerisation using Docker and automated CI/CD pipelines to facilitate continuous integration and delivery.

Advantageously, the server 102 is scalable and maintainable, capable of handling multiple client requests efficiently while centralising processing, business logic and data management, thereby enabling a seamless user experience for end users.

In some embodiments, the backend and database specifications are as shown in Table 7.

TABLE 7
Backend and database specifications

| | |
|---|---|
| Language | Node.js |
| Rest API's Framework | Loopback/Express.js |
| Frontend | React JS with HTML and CSS |
| Token Authentication | JWT |
| Transactional Emails | Amazon SES |
| ML/DL | TensorFlow.js |
| Relational Database | PostgreSQL/MySQL & ORM/MariaDB |
| Non-Relational Database | MongoDB |
| Server | Apache 2.4/Nginx |
| CDN | Amazon CloudFront |
| Data backup and image storage | Snapshot AMI, S3 |
| Cloud Hosting | Amazon Linux hosting |
| Caching server | Redis |

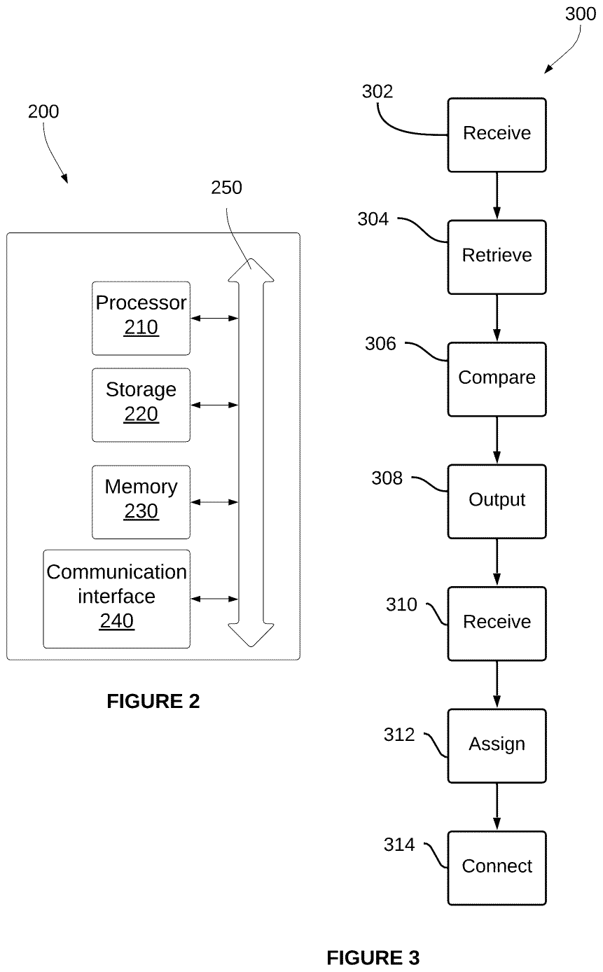

FIG. 2 is a block diagram of an example embodiment of a computing device 200 that can be used in the system described herein, for example as a client device 106 and/or a server 102 as shown in FIG. 1 of the drawings. Each computing device 200 includes a processor 210, storage 220, memory 230, and a communication interface 240 (also referred to as a “data interface” herein) for communicating with other computing devices. The various components of the computing device 200 are interconnected via a bus 250. This configuration may be implemented using a bespoke computing device, or in one or all embodiments standard devices such as a mobile phone, tablet, desktop computer, laptop or the like may be used.

FIG. 3 is a flow diagram of a method 300 for matching a user and a collocated service provider. The matching server 102 comprises a processor 210 configured to receive (at 302) a match request from the user, the match request comprising match parameters comprising a physical location. The method then includes retrieving (at 304) service provider profiles from the database based on the match parameters.

At 306 the match parameters are compared with service provider profile parameters to identify one or more matching service providers, and then at 305 a service request is output to the one or more matching service providers. Upon receiving a service accept message from a matching service provider at 310, the server then assigns a service provider at 312. The server then connects (at 314) a client device associated with the match request and a client device associated with the assigned service provider.

Identifying the one or more matching service providers at 306 may include comparing the match parameters with the service provider profile parameters to determine a service provider shortlist, providing the service provider shortlist to the service request user, and receiving a user selection used to identify the one or more matching service providers.

FIG. 4A shows an example of a client user interface for a requestor. The user can select “get started” to create a new account, or select “login” to use an existing account to create a new request and check the status of a request.

FIG. 4B shows an example of a client user interface for a service provider. A service provider can select “get started” to create a new account, or select “login” to check the status of an existing booking or to view available requests.

FIG. 4C is an example of a client user interface for a requester where a security code is entered to confirm a booking. FIG. 4C shows the secure login interface 420. An OTP entry field 422 accepts a one-time code and, once the user has been verified, the method of connecting user 700 will be able to commence by receiving a request 702 (refer to FIG. 7 of the drawings).

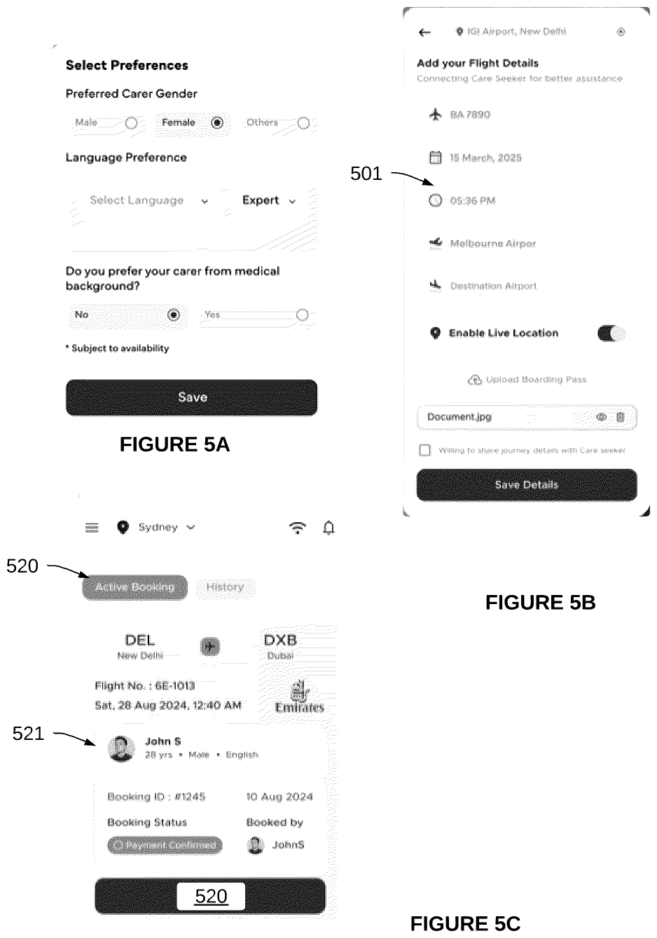

FIG. 5A shows an example of a client user interface for a requestor creating a new request. Various request parameters can be selected, such as gender, language, service provider credentials or qualifications, etc.

FIG. 5B is another embodiment of a client user interface for a requestor creating a request. In this example, the request is for a service provider during a flight, and the flight details are entered and associated with the request. FIG. 5B shows the first stage of request creation.

Entering relevant details (e.g., route, time window, capability requirements, etc.) in form fields 501 updates events. In some embodiments, “request_draft_updated” events may be emitted, following which the backend returns a draft request identifier and a provisional candidate set.

FIG. 5C shows an example of a client user interface showing booking details for a booked service. The details displayed include flight details and requestor details, as well as payment confirmed details. In alternative embodiments, the displayed booking details may include other information such as the service provider details. FIG. 5C shows the booking detail screen for an approved or pending match. A connection-state banner 520 renders the current state supplied by the orchestrator and updates in response to state-change notifications. A disclosure block 521 displays tokenised or revealed fields according to the disclosure matrix; transitions between states cause the client to re-render with fields masked, tokenised, or revealed as instructed. Communication controls 522 (message, voice, video) are enabled or disabled based on state, and activating a control emits a “comm_requested” event that is accepted only if state permits.

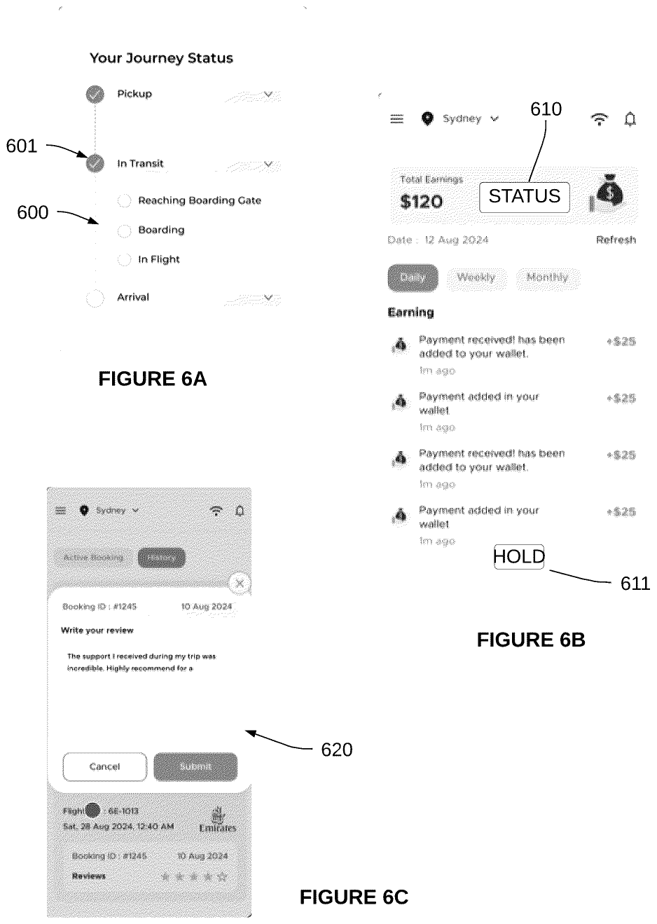

FIG. 6A shows an example of a user interface showing the status of service provision. Steps or parts of a service are displayed separately, and ticked off as they are completed. FIG. 6A shows the in-progress service status with a step list or checklist 600. A checkpoint confirmation control 601 emits a “proof_of_presence” event (for example, gate reached, handover completed); specialised devices may sign these events and the backend records them for risk and payout logic. If an adverse signal is received, a pause or rollback banner may appear and the client then disables communications; this is driven by an “orchestrator_state_changed” notification.

FIG. 6B shows an example of a user interface showing payments received by a service provider. In this embodiment, the system includes an e-commerce module to facilitate payments from the requestor to the provider. A “proof_of_travel satisfied” indicator 610 reflects backend evaluation of signals such as arrival geofence or carrier status; when satisfied and risk is clear, the wallet emits a “payout_released” event. If conditions are not met, a payout hold row 611 is shown with a summary derived from the decision record, and the backend records a “payout_on_hold” event.

FIG. 6C shows an example of a user interface for providing a review associated with a completed service. The review may include, for example, a star rating and/or a comment. The review may be visible to other users, and/or may be used by the system and/or an administrator when assigning providers for future requests. Submitting a star rating and comment 620 emits a “feedback_submitted” event; the Risk Engine consumes aggregates of this signal for calibration, and the orchestrator may incorporate it into future threshold adjustments.

An example embodiment is described in Table A. Features, ranges and normalization. Each feature function maps its underlying signals to a value in the interval [0,1], where a higher value indicates better compatibility. For bounded quantities, the system uses min-max scaling, and for unbounded quantities such as distance and latency it applies domain-specific transforms. The default features and transforms are as follows.

Proximity has weight 0.20. The inputs are distance_km between the carer's homeAirport and the targetAirport, route_overlap in [0,1] computed as the Jaccard overlap of route tokens, and airport_region_match in {0, 1}. The transforms are prox_distance=exp(−distance_km/50), prox_route=route_overlap, and prox_region=airport_region_match. The aggregated proximity feature is Proximity=0.6×prox_distance+0.3×prox_route+0.1×prox_region.

Availability has weight 0.20. The inputs are the seeker and carer time windows and any relevant flight schedule intervals, all expressed in minutes. The transform computes overlap_fraction=overlap_minutes divided by the minimum of seeker_window_minutes and carer_window_minutes, clipped to [0,1]. A penalty multiplier of 0.85 is applied if overlap_fraction is less than 0.25. The feature value is Availability=overlap-fraction×penalty.

Skill Fit has weight 0.15. The inputs are the required skill tags compared with the carer's skill tags using a knowledge-base-guided taxonomy, with an optional medicalBackground requirement. The transform computes skill_jaccard=|intersection|/|union| in [0,1]. A bonus of +0.05 is added if medicalBackground explicitly matches the requirement, and the result is clipped to 1.

Language Fit has weight 0.10. The inputs are the shared languages array with optional preference weights. The transform is a weighted overlap computed as the sum over i of min(pref_seeker[i], prof carer[i]) divided by the sum over i of pref_seeker[i], yielding a value in [0,1].

Price Fairness has weight 0.10. The inputs are the carer's priceRange compared with the seeker's budget and the outcome of the policy engine. The transform computes price_fit=1−|mid(priceRange) −budget|/max(budget, mid(priceRange)), clipped to [0,1]. If the minimum pricing engine flags a violation, the policy penalty sets price_fit to 0.

Trust and Verification has weight 0.15. The inputs are verificationStatus in {verified, pending, declined}, rating in [1,5], and referralTrustScore in [0,1]. The transform maps verify as verified→1, pending→0.5, declined→0, computes rating_norm=(rating −1)/4, and sets trust_norm=referralTrustScore. The aggregated feature is Trust=0.5×verify+0.3×rating_norm+0.2×trust_norm.

Activity and Responsiveness has weight 0.10. The inputs are lastActiveMinutes and responseLatencySeconds. The transforms compute activity=exp(−lastActiveMinutes/1440) and responsiveness=exp(−responseLatencySeconds/300). The aggregated feature is Activity=0.6×activity+0.4×responsiveness.

The compatibility score S is the weighted sum of the normalized feature values using the specified weights, producing a value in [0,1] that the orchestration engine uses for ranking and decision policies.

TABLE A
Example Embodiment

A. 1 Features, Ranges/Units, Normalization All feature functions map
underlying signals to ‘[0,1]’ where higher is better compatibility. We use
min-max scaling for bounded quantities and domain-specific transforms for
unbounded ones (e.g., distance, latency).
Defaults:
1) Proximity (weight 0.20) - Inputs: ‘distance_km(homeAirport ↔
targetAirport)’, ‘route_overlap ϵ [0,1]’ (Jaccard overlap of route tokens),
‘airport_region_match ϵ {0,1}’. - Transform: ‘prox_distance = exp(−distance_km
/ 50)’; ‘prox_route = route_overlap’; ‘prox_region = airport_region_match’. -
Aggregation: ‘Proximity = D6*prox_distance + 0.3*prox_route +
0.1*prox_region’.
2) Availability (weight 0.20) - Inputs: Time windows and flight schedule
intervals in minutes. - Transform: ‘overlap_fraction = overlap_minutes /
min(seeker_window_minutes, carer_window_minutes)’ clipped to ‘[0,1]’. -
Penalty: If overlap < 0.25, apply ‘0.85’ multiplier. - ‘Availability =
overlap_fraction * penalty’.
3) Skill Fit (weight 0.15) - Inputs: Required skill tags vs. carer skill tags
(KB-guided taxonomy), optional medical background. - Transform: ‘skill_jaccard
= |intersection| / |union|’ in [0,1]’. - Bonus: ‘+0.05’ if ‘medicalBackground’
explicitly matches requirement (clipped to ‘1’).
4) Language Fit (weight 0.10) - Inputs: Shared languages array with optional
preference weights.
- Transform: Weighted overlap: ‘Σ(min(pref_seeker[i]. prof_carer[i])) /
Σ(pref_seeker[i])’ in ‘[0,1]’.
5) Price Fairness (weight 0.10) - Inputs: Carer ‘priceRange’ vs. seeker budget
and policy engine outcome.
− Transform: ‘price_fit = 1 − |mid(priceRange) − budget|/ max (budget,
mid(priceRange))’, clipped ‘[0,1]’.
- Policy penalty: If minimum pricing engine flags violation, set ‘price_fit =
0’.
6) Trust & Verification (weight 0.15) - Inputs: ‘verificationStatus ϵ
{verified, pending, declined}’, ‘rating ϵ [1,5]’, ‘referralTrustScore ϵ [0,1]’
- Transform: ‘verify = {verified:1, pending 0.5, declined: 0}’, ‘rating_norm =
(rating−1)/4’, ‘trust_norm = referralTrustScore’. - Aggregation: ‘Trust =
0.5*verify + 0.3*rating_norm + 0.2*trust_norm’.
7) Activity & Responsiveness (weight 0.10) - Inputs: ‘lastActiveMinutes',
‘responseLatencySeconds'.
-Transform: ‘activity = exp(−lastActiveMinutes / 1440)’; ‘responsiveness =
exp(−responseLatencySeconds / 300)’. - Aggregation: ′Activity = 0.6*activity +
0.4*responsiveness'.

In another example embodiment, the system computes a compatibility score S for three candidate counterpart users C1, C2, and C3 for a given request by a first user. The score is a weighted sum of normalized feature values f1 . . . f6 in the closed interval [0,1], where the weights w1 . . . w6 are non-negative and sum to 1. The features in this example comprise route or location alignment (f1), schedule alignment (f2), language match (f3), capability or skill match (f4), historical reliability (f5), and verification level (f6). The weights are selected as w={0.25, 0.20, 0.15, 0.15, 0.15, 0.10}. The normalized features for each candidate are:
C1: {0.90, 0.80, 1.00, 0.70, 0.85, 1.00}
C2: {0.85, 0.90, 0.60, 0.90, 0.80, 0.80}
C3: {0.70, 0.60, 0.90, 0.60, 0.95, 0.90}

Applying S=Σ wj·fj yields S(C1)=0.8725, S(C2)=0.8225, and S(C3)=0.7650.

Using example thresholds described herein, C1 is ranked first and qualifies as a strong match; C2 is a strong match but ranked second; C3 is marginal and would be listed for explicit acceptance rather than automatically approved. Where two candidates tie within a tolerance band, the system resolves the tie using secondary criteria that prefer higher verification, higher reliability, and lower risk, before falling back to earlier registration time where necessary.

Described examples are illustrative and non-limiting. Numerical values, thresholds, features and field sets may be adjusted for a particular deployment while maintaining the described technical effects of integrated, state-driven matching, calibrated risk assessment, and staged, tokenised disclosure governed by the orchestration engine.

### Example Embodiments: Support Services

In some embodiments one or more of the following services may be supported by the systems and methods described herein.

The service provider meets the service user at the designated point, such as the arrival gate, terminal entrance, or curb side drop-off, ensuring that the service user has all required travel documents handy, including tickets, passports, and any special documents required for medical emergency situations and proof of disability. The service provider assists the service user with luggage, segregating in-cabin baggage and check-in baggage, getting a trolley for the luggage, or arranging porter service, and ensuring a smooth entry into the airport.

The service provider provides support in handling and transporting the service user's luggage using trolleys. This includes assisting travellers in locating and securing a trolley, helping with loading and unloading heavy or bulky luggage onto the trolley, guiding the service user with trolleys to appropriate destinations such as check-in counters, boarding gates, exits, or transportation areas, providing clear instructions for using trolleys effectively, and ensuring a smoother and more efficient flow of movement in crowded areas.

The service provider assists the service user with managing, transporting, and organizing their luggage during the flight journey. This involves assisting with lifting and loading luggage into luggage trolleys, in-cabin overhead storage units, in-transit vehicles, and unloading luggage at destinations such as check-in/out counters and terminals, escorting the service user and their luggage to desired locations, including gates, baggage claim, or pick-up points, assisting with tagging and ensuring all luggage is labelled correctly for easy identification, arranging and organizing bags to optimize space and secure fragile items, guiding the service user through luggage screening, check-in processes, ensuring bags meet airline requirements, advising on excess baggage solutions, including repacking or payment options for additional weight, and coordinating with porters or concierge services to ensure seamless luggage transfer.

The service provider helps the service user identify various travel documents like passports, visas, eTA/ESTA, entry permits, health documentation, proof of vaccinations, and health certifications required for identification by airport authorities. The service provider assists the service user in handing over documents to immigration officials or automated systems to verify the traveller's identity using documents, photos, or biometric data such as fingerprints or facial recognition.

The service provider assists the service user with their wheelchair at various points during air travel. Assistance starts at the check-in counter, where the service provider helps with check-in procedures, baggage drop-off, and any other requirements, and escorts the service user to a dedicated area for priority check-in. The service provider navigates through security checkpoints, assists with equipment, and ensures all security protocols are followed. The service provider provides wheelchair assistance and navigation through passport control and immigration, navigates accessible lounges for the service user to relax before flights, and helps wheelchair users board the aircraft either by assisting with walking down the jet bridge or using an aisle chair for transfer onto the aircraft. Upon landing, the service provider assists service users in getting off the plane and to their next destination, whether it's baggage claim or a connecting flight. The service provider assists through priority security screening when available or booked, navigates dedicated lanes for faster processing, and uses ramps and elevators for accessing different levels of the terminal building. The service provider navigates through wheelchair-accessible toilets, seating areas, and other amenities provided at the airport.

The service provider supports the service user in queues, including access to priority queues. Assistance is provided to passengers with disabilities, elderly passengers, families with young children, pregnant passengers, and frequent flyers or premium passengers. The service provider assists the service user during the check-in process, coordinating with airline staff to ease checking in, printing boarding passes, confirming flight details, handling special requests, and navigating self-service kiosks. The service provider assists in navigating to dedicated assistance desks or counters for passengers with special needs, navigating priority or fast-track check-in counters, assisting with luggage, and communicating special seating requests and medical needs to airline authorities. The service provider assists with managing travel documents, ensuring all necessary paperwork is verified, and communicating additional special requests.

The service provider supports the service user in managing their carry-on or hand luggage throughout various stages of their airport journey, including organizing and preparing hand luggage for check-in and security screenings, meeting airline size and weight requirements, assisting through security checks, lifting hand luggage into overhead cabins or onto security conveyor belts, and providing physical support for service users unable to carry or manage their hand luggage independently. The service provider escorts the service user with their hand luggage to departure gates, lounges, or other airport facilities, ensures that hand luggage is securely stowed during the boarding process, helps retrieve items from overhead bins, and coordinates with airport staff for quick resolutions in case of lost items.

The service provider assists the service user during various procedures of immigration, including guiding them to designated immigration counters, presenting travel documents, supporting identity verification, assessing the purpose of travel, presenting supporting documents, verifying traveller information against security databases, and assisting with passport stamping and clearance processes.

The service provider assists the service user during boarding by providing clear directions and escorting service users from security checkpoints, lounges, or other airport areas to their designated boarding gate, ensuring the service user reaches the gate well before boarding time, informing about the boarding sequence, and supporting special needs passengers with reduced mobility or families with small children. The service provider helps manage carry-on baggage, provides language support for understanding boarding instructions, coordinates with gate agents to resolve any last-minute issues, and facilitates boarding passes or travel documents.

The service provider assists the service user during toilet breaks at various stages of travel, including navigating to airport restroom facilities before boarding, guiding to airplane lavatories, offering discreet support, coordinating with cabin crew for extra time or privacy, using lavatories with enhanced accessibility features, and suggesting seat exercises for long-haul flights. The service provider supports in layovers by finding restrooms, offering quick guidance during tight layovers, and alerting crewmembers about specific needs.

The service provider provides in-flight assistance to the service user, explaining safety procedures, securing during turbulence, coordinating during emergencies, locating and settling into assigned seats, stowing and retrieving carry-on items, guiding to lavatories, communicating special meal requests, providing discreet feeding assistance, encouraging hydration, reminding medication schedules, informing crew about medical needs, providing support to elderly passengers and passengers with disabilities, and assisting families with young children. The service provider also assists with in-flight entertainment systems, connecting personal devices, enabling language preferences, closed captions, and subtitles, troubleshooting system errors, distributing and setting up headphones, and customizing content based on preferences.

The service provider assists the service user during terminal changes by providing clear instructions for navigating from one terminal to another, guiding to shuttle buses, monorails, or terminal trains, directing through safe routes, arranging private transport options, ensuring checked bags are transferred correctly, assisting with hand luggage, ensuring travel documents are ready for inspection, providing up-to-date information on flight schedules, offering mobility assistance, and ensuring inclusive pathways for service users with disabilities.

The service provider assists the service user with baggage collection, guiding them to the baggage claim area, interpreting signage, directing to the correct carousel, helping identify and retrieve luggage, coordinating priority baggage handling, ensuring luggage tags and information are correct, handling special baggage, filing claims for lost or delayed baggage, informing about excess baggage fees, providing trolleys, helping load luggage onto trolleys, connecting to transportation, coordinating hotel delivery services, and tracking luggage through the airline's system.

The software platform may be configured to provide predetermined and defined combinations of functionality (and services). For example, three service level combinations may be provided when the methods are applied to travel, as shown in Tables 8-11.

TABLE 8
Support Service Combinations for Travel Departures

| | | | | |
|---|---|---|---|---|
| DEPARTURES | Meet and Greet | [symbol] | [symbol] | [symbol] |
| Entry at Airport | Luggage Trolley Assistance | [symbol] | [symbol] | [symbol] |
| | Security clearance for entry | [symbol] | [symbol] | [symbol] |
| | (Travel documents) | | | |
| | Proceed to Check-in counter | [symbol] | [symbol] | [symbol] |
| | Wheelchair Assistance* | [symbol] | [symbol] | [symbol] |
| Check in Airline | Que-in Assistance | [symbol] | [symbol] | [symbol] |
| Counter | Check-in (Travel documents) | [symbol] | [symbol] | [symbol] |
| | Check-in Luggage drop | [symbol] | [symbol] | [symbol] |
| | Hand Luggage Assistance*** | [symbol] | [symbol] | [symbol] |
| | Proceed to security check | [symbol] | [symbol] | [symbol] |
| | Wheelchair Assistance* | [symbol] | [symbol] | [symbol] |
| Security Check | Que-in Assistance | [symbol] | [symbol] | [symbol] |
| | Hand Luggage Assistance*** | [symbol] | [symbol] | [symbol] |
| | Proceed to Immigration | [symbol] | [symbol] | [symbol] |
| | Wheelchair Assistance* | [symbol] | [symbol] | [symbol] |
| Immigration Check [symbol] | Que-in Assistance | [symbol] | [symbol] | [symbol] |
| | Check-in (Travel documents) | [symbol] | [symbol] | [symbol] |
| | Proceed to gate/lounge | [symbol] | [symbol] | [symbol] |
| | (if applicable) | | | |
| | Wheelchair Assistance* | [symbol] | [symbol] | [symbol] |
| Boarding Gate | Drinks and buying Assistance | [symbol] | [symbol] | [symbol] |
| | Toilet and break Assistance | [symbol] | [symbol] | [symbol] |
| Boarding | Waiting at boarding gate | [symbol] | [symbol] | [symbol] |
| | Que-in Assistance | [symbol] | [symbol] | [symbol] |
| | Boarding to plane including travel | [symbol] | [symbol] | [symbol] |
| | documents | | | |
| | Proceed to flight | [symbol] | [symbol] | [symbol] |
| | Wheelchair Assistance* | [symbol] | [symbol] | [symbol] |
| In Flight | Finding the seat | [symbol] | [symbol] | [symbol] |
| | Hand Luggage storage in overhead | [symbol] | [symbol] | [symbol] |
| | cabin | | | |
| | Entertainment system operations | [symbol] | [symbol] | [symbol] |
| | Assistance | | | |
| | Communication with Airline staff | [symbol] | [symbol] | [symbol] |
| | including any errands e.g. food and | | | |
| | beverage order Assistance etc | | | |
| | Toilet Assistance | [symbol] | [symbol] | [symbol] |
| | Medical need (medicine only) or | [symbol] | [symbol] | [symbol] |
| | assistance** | | | |

TABLE 9
Support Service Combinations for Travel in Transit

| | | | | |
|---|---|---|---|---|
| IN TRANSIT | Hand luggage de-storage from overhead | [symbol] | [symbol] | [symbol] |
| | cabin | | | |
| Deboarding | Assistance in de-boarding the aircraft | [symbol] | [symbol] | [symbol] |
| | (Wheelchair Assistance in Premium | | | |
| | only)* | | | |
| | Luggage Trolley Assistance | [symbol] | [symbol] | [symbol] |
| Terminal Change | Finding the terminal and gate | [symbol] | [symbol] | [symbol] |
| (if applicable) | Proceed to terminal and gate | [symbol] | [symbol] | [symbol] |
| Reaching | Drinks and food buying assistance | [symbol] | [symbol] | [symbol] |
| Boarding Gate | Toilet and break assistance | [symbol] | [symbol] | [symbol] |
| Boarding | Waiting at boarding gate/lounge | [symbol] | [symbol] | [symbol] |
| | (if applicable) | | | |
| | Que-in Assistance | [symbol] | [symbol] | [symbol] |
| | Boarding to plane including travel | [symbol] | [symbol] | [symbol] |
| | documents | | | |
| | Proceed to flight | [symbol] | [symbol] | [symbol] |
| | Wheelchair Assistance* | [symbol] | [symbol] | [symbol] |
| In Flight | Finding the seat | [symbol] | [symbol] | [symbol] |
| | Hand luggage storage in overhead cabin | [symbol] | [symbol] | [symbol] |
| | Entertainment system operations | [symbol] | [symbol] | [symbol] |
| | assistance | | | |
| | Communication with airlines staff | [symbol] | [symbol] | [symbol] |
| | including any errands e.g. food and | | | |
| | beverage order assistance etc. | | | |
| | Toilet Assistance | [symbol] | [symbol] | [symbol] |
| | Medical need (medicine only) or | [symbol] | [symbol] | [symbol] |
| | assistance** | | | |
| | Assistance in completing arrival card | [symbol] | [symbol] | [symbol] |

TABLE 10
Support Service Combinations for Travel at Arrivals

| | | | | |
|---|---|---|---|---|
| ARRIVALS | Hand luggage de-storage from overhead | [symbol] | [symbol] | [symbol] |
| | cabin | | | |
| Deboarding | Assistance in de-boarding the aircraft | [symbol] | [symbol] | [symbol] |
| | (Wheelchair assistance in Premium | | | |
| | only*) | | | |
| | Proceed to Immigration | [symbol] | [symbol] | [symbol] |
| | Toilet and break assistance | [symbol] | [symbol] | [symbol] |
| | Que-in Assistance | [symbol] | [symbol] | [symbol] |
| Immigration [symbol] | Check-in (Travel documents) | [symbol] | [symbol] | [symbol] |
| | Proceed to luggage carousel | [symbol] | [symbol] | [symbol] |
| | Wheelchair Assistance* | [symbol] | [symbol] | [symbol] |
| | Arrange Trolley for Luggage | [symbol] | [symbol] | [symbol] |
| Baggage | Luggage identification & unload from the | [symbol] | [symbol] | [symbol] |
| Collection | carousel to trolley | | | |
| | Proceed to customs | [symbol] | [symbol] | [symbol] |
| | Luggage Trolley Assistance | [symbol] | [symbol] | [symbol] |
| | Wheelchair Assistance* | [symbol] | [symbol] | [symbol] |
| | Customs queries assistance | [symbol] | [symbol] | [symbol] |
| | (interpretation only) | | | |
| Customs [symbol] | Luggage Assistance if customs request | [symbol] | [symbol] | [symbol] |
| | inspection**** | | | |
| | Proceed to exit | [symbol] | [symbol] | [symbol] |
| | Wheelchair & Luggage Assistance* | [symbol] | [symbol] | [symbol] |
| | Handover to receiver | [symbol] | [symbol] | [symbol] |
| Exit | Arranging a phone call | [symbol] | [symbol] | [symbol] |
| | Arranging a transport | [symbol] | [symbol] | [symbol] |

TABLE 11
Key for Support Service Combinations for Travel

| | |
|---|---|
| [symbol] → | Only Applicable to International Travel |
| * → | Subject to Airport and Airline approval |
| ** → | Medicine only Assistance (must be supplied by the Care Seeker |
| | to the Carer) |
| *** → | Carer will provide Assistance with the Care Seeker's hand |
| | luggage |
| **** → | Carer is not responsible for Care Seeker's luggage contents. |
| | Carer only provides assistance in opening and closing the |
| | luggage |

### Example Embodiment: Travel Kiosk

In some embodiments, the platform described herein is implemented using a specialised handheld terminal issued to carers by the platform operator or by an authorised airport or transport partner, instead of relying on a general-purpose smartphone controlled by the carer. The handheld terminal is a rugged, dedicated device designed for operation in airport and transport environments and includes integrated cellular and Wi-Fi communications, a GNSS receiver for location tracking, a barcode and boarding pass scanner, an NFC reader, and a secure hardware element such as a secure enclave or hardware security module. The device is provisioned at manufacture or enrolment time with a unique device identifier and one or more cryptographic keys, and is enrolled with the backend orchestration system so that it is recognised as a trusted endpoint.

The firmware of the handheld terminal is configured to run only an approved client application associated with the platform and to prevent installation or execution of arbitrary third-party software. The secure element or equivalent protected memory region stores the unique device identifier, long-term keys, attestation material, and short-lived access tokens, and is arranged to prevent extraction or modification of those values by local users. The device enforces strong operator authentication, for example by requiring a biometric check or a personal identification number that is cryptographically bound to the device identifier, before the platform client may be used. In this way, each action performed through the terminal can be associated both with a particular authorised operator and with a particular trusted device instance.

The client application on the specialised handheld terminal communicates exclusively with the central orchestration engine of the platform over authenticated and encrypted channels. It receives, from the orchestration engine, only those matches, tasks, and assignments that have already been evaluated under the multi-signal compatibility scoring, risk scoring, and decision policies described elsewhere in this specification. When a carer logs in on the terminal, the device fetches the relevant assignments, displays route and timing information, and presents only the minimum traveller information that the orchestration engine has authorised for disclosure at the current stage of the workflow. At an initial stage, this may be limited to pseudonymous identifiers or a simple instruction such as proceeding to a particular gate to meet a traveller, without revealing full name or contact details.

During operation, the terminal continuously or periodically reports its location, status, and event confirmations back to the orchestration engine. These reports are signed or otherwise authenticated using keys stored in the secure element so that the backend can verify that the signals originate from a legitimate, registered device operating in the expected region. This allows the platform to obtain high-integrity confirmation that a carer is physically present at specific checkpoints such as check-in counters, security entrances, boarding gates, or arrival halls, and to incorporate such information into proof-of-service, risk reassessment, and fraud detection logic.

When a traveller presents at the meeting point, the carer may use the handheld terminal to scan the traveller's boarding pass or identification document using the integrated scanner or NFC reader. The client application extracts relevant data, such as the flight number, date, booking reference, and a limited portion of the name, and transmits either that data or a pseudonymised token derived from it to the backend via a secure API call. The orchestration engine verifies that the scanned information corresponds to the booking and assignment previously created for that traveller-carer pairing. The handheld then displays a clear indication to the carer that the correct traveller has been identified, again revealing only those personal details that are permitted at that stage under the staged disclosure policy.

The specialised terminal implements the staged disclosure framework in a technically enforced manner. At early stages, the device may show only initials, high-level descriptors, or colour-coded confirmation symbols. As the orchestration engine determines that conditions are satisfied, such as mutual acceptance, location confirmation, or completion of checks, it may send updated disclosure instructions to the device, authorising display of additional details such as the traveller's full first name, accessibility needs, or itinerary notes. The device software is configured not to store full personal details beyond what is necessary for the active assignment, to clear sensitive data from the screen and memory after use, and to disable or prevent screenshots, local export, or forwarding of that data to external applications or destinations.

For real-time communication, the handheld terminal uses a dedicated, integrated VoIP or signalling stack that is bound to the platform's secure signalling architecture. Voice and, where applicable, video calls or secure messages between the carer and the traveller, or between the carer and a control centre, are initiated and managed only through the orchestrated secure channel defined by the system, using authenticated endpoints and encrypted signalling and media paths. Direct dialling of the traveller's underlying telephone number from the device may be disabled; instead, calls are placed using virtual identifiers or internal session identifiers allocated by the platform. This ensures that communication remains subject to the same risk, privacy, and audit controls as the matching and disclosure processes.

The specialised handheld terminal further records, in secure storage, event logs such as assignment receipt, check-in scans, location-confirmed arrivals at checkpoints, call initiation and completion, and handover confirmations. These logs may be signed or otherwise protected using keys in the secure element and uploaded to the backend, enabling the platform to reconstruct the sequence of events and verify that the orchestration policies were followed. By constraining software execution, binding credentials and policies to tamper-resistant hardware, enforcing staged disclosure and secure communication at the device level, and providing authenticated operational signals back to the orchestration engine, this embodiment provides a special-purpose client device that functions as a trusted enforcement and sensing point within the overall decision framework, rather than merely hosting a generic application on an uncontrolled general-purpose device.

In another embodiment, comparable to the handheld devices, the system is implemented in kiosks or gate-side terminals located at airports, transport stations, or secure buildings and configured as trusted enforcement points for the platform's matching, risk, and disclosure rules. Each kiosk is equipped with one or more input devices such as a boarding pass or ticket scanner, government ID reader, and optionally a biometric sensor, together with a secure processor, display, and network interface. When a traveller presents themselves at the kiosk, the kiosk acquires identification data from the boarding pass, ID, or biometric input and securely transmits that data, or a pseudonymised token derived from it, to the central orchestration engine. In response, the orchestration engine determines whether the traveller has an assigned assistant, escort, or carer within the platform, and what information about that assignment and about the traveller is permitted to be shown at that checkpoint under the applicable compatibility, risk, and staged disclosure policies. Based on the decision returned by the orchestration engine, the kiosk displays only the authorised information to staff or to the assigned carer, such as a confirmation that a particular traveller is to be met, a location or gate number, or a minimal identifier that allows the carer to confirm the correct person without exposing unnecessary personal details. The kiosk may also print or display on-screen tokens, codes, or QR markers that are meaningful only within the orchestrated framework and serve as cryptographically verifiable proofs of checkpoint passage, assignment confirmation, or handover, which can be scanned or consumed by authorised handheld devices or backend systems. By ensuring that all such actions are driven by centrally defined decision policies and by preventing local override of match, risk, and disclosure rules, the kiosk functions as a specialised client device that enforces the platform's safety and privacy logic at critical access points.

### Example Embodiment: In-Home Assistance

In another embodiment, the decision framework is implemented in a dedicated assistance terminal installed in a private home, shared residence, clinic, hospital, or assisted-living facility, configured as a trusted endpoint rather than a general-purpose tablet. The terminal may be a mains-powered, wall-mounted or docked device with a touch display, integrated speaker and microphone, optional camera, network interfaces (wired Ethernet, Wi-Fi, or cellular), and one or more sensors or readers such as a barcode scanner, NFC reader, or biometric sensor. At manufacture, enrolment, or installation, the terminal is provisioned with a unique device identifier and one or more cryptographic keys, and is registered with the backend orchestration system so that it is recognised as an authorised device for a specific location, care organisation, or patient context. The device firmware is configured to execute only an approved assistance application associated with the platform and to prevent installation or use of arbitrary applications or browsers, thereby reducing the risk of exfiltration or interference. A secure enclave or equivalent protected hardware region stores the device credentials, policy configuration, and optionally a cache of recent matching and risk decisions relevant to the assigned premises or patients, such as pre-approved carers, upcoming visits, and permitted disclosure levels.

In operation, the terminal presents to patients, residents, or local staff only those carers, visit slots, and communication options that have been pre-filtered and authorised by the central orchestration engine in accordance with the multi-signal compatibility scoring, risk evaluation, and privacy rules described elsewhere in this specification. For example, where a recurring home-visit arrangement exists, the terminal can display the identity or pseudonymous identifier of the next expected carer, the scheduled time window, and high-level information about the visit, without exposing unnecessary personal data about the carer until their arrival is authenticated. When a carer arrives on site, they can authenticate themselves at the terminal using a secure method such as scanning a code from their own authorised device, tapping an NFC credential, entering a PIN, or presenting a biometric (for example, fingerprint or facial recognition) if enabled. The terminal verifies this information with the backend or against locally cached keys, confirms that the carer is the one assigned to the visit under the current risk and policy conditions, and, upon successful verification, may reveal additional information such as the patient's name, room or unit, and specific care instructions appropriate for that visit. If the verification fails or if the orchestration engine has updated the risk profile such that the assignment is no longer permitted, the terminal can deny access, refrain from disclosing sensitive details, and prompt for alternative actions such as contacting a control centre.

The terminal can also use its built-in camera, microphone, or biometric sensors to capture proof-of-service events in a privacy-controlled way, such as confirming that a handover or treatment has occurred, recording that medication has been administered, or verifying that a particular patient interacted with the authorised carer. These confirmations are cryptographically bound to the terminal's identity and transmitted to the orchestration system as authenticated status signals, where they are incorporated into audit logs, billing or payout rules, and, where relevant, the risk scoring models. Throughout operation, the terminal enforces strict restrictions on the export and storage of identity data and logs. Detailed personal information, if displayed at all, is held in volatile memory only for as long as needed for the immediate interaction, and the device is configured to prevent screenshots, raw log downloads, arbitrary data copying, or redirection of traffic to unauthorised endpoints. Persistent logs stored on the terminal, where required for resilience, may be encrypted and limited to pseudonymous identifiers and event codes that can be resolved only by the backend using protected keys. By combining pre-provisioned credentials, a locked-down execution environment, curated presentation of orchestrator-approved options, integrated verification and proof-of-service capture, and restricted data handling, the in-home or clinical assistance terminal operates as a specialised client device that implements and enforces the platform's matching, risk, and staged-disclosure decisions in a controlled care environment, rather than acting as a generic consumer tablet merely running an application.

### Advantages

Described herein is a risk-aware, privacy-preserving orchestration engine that automatically forms or suppresses matches between parties using a combined compatibility score and calibrated risk scores, with controlled information disclosure, explanations, and rollback.

The orchestration engine described herein does not simply “recommend” a user pairing or user connections, but continuously decides whether two parties should be connected at all, what they are allowed to see about each other, and how the system should react if new information changes the risk.

Concretely, this engine:
a. Calculates a structured compatibility score between two parties from multiple signals (such as timing, location, skills, preferences, history and verification), using a defined, reproducible formula.
b. Calculates robust, calibrated risk scores for each party and for the specific combination of those parties in their context (the pairwise risk), using machine-learned models with monotonic and safety constraints.
c. Applies explicit policies and thresholds over both the compatibility and risk values to route each potential interaction into one of several system states, such as: automatically approved and connected; visible as a suggestion requiring mutual acceptance; held back for administrator review; or suppressed entirely.
d. Ties those state decisions to a staged disclosure mechanism which controls which pieces of personal or sensitive information are shown at each state, so that only limited, low-risk information is visible when risk is uncertain, and richer information or communication options are revealed only once the decision engine is satisfied that defined safety conditions are met.
e. Generates and stores explanations and structured decision records for each such outcome (including the key factors that increased or decreased compatibility and risk) so that the decisions are auditable and can be refined over time.
f. Monitors for new signals (such as disputes, fraud events, or other risk indicators) and, if received, automatically re-evaluates prior matches and can roll them back, suspend communication, or require review, based on the same combined scoring and policy logic.

This integrated framework results in a platform that does not treat matching, risk checks, privacy controls, and audit logging as separate, ad hoc features. Instead, it defines a coherent, technically specified orchestration mechanism that jointly uses multi-signal scoring, calibrated and constrained risk models, and pairwise/context-aware risk, directly drives automatic match/hold/block decisions, dynamically governs which user data is revealed at each step, and maintains explainable, verifiable records and rollback behaviour.

The systems and methods described herein provide a number of technical advantages over conventional platforms.

In one aspect, the integrated orchestration engine improves the safety and relevance of automated connections between users. By combining multi-signal compatibility scoring with calibrated profile and pairwise risk scores, and applying explicit decision policies, the platform can decide not only who should be suggested or approved, but also when a connection must be withheld, downgraded or reviewed. This leads to more appropriate and reliable matching outcomes than systems that rely solely on simple search filters or unstructured recommendations.

In some embodiments, the system computes a multi-signal compatibility score S for each candidate provider relative to a seeker. The score is a weighted sum of normalised feature values.

Each feature is normalised to a value between 0 and 1, and each feature has an associated weight, with the weights summing to 1. Example features include:
a. flight match (with a value of 1.0 for an identical flight, 0.7 for the same airline and overlapping time window, and 0 for no relevant match);
b. location proximity (with a value of 1.0 for distance up to 250 meters decreasing linearly to 0 at 5 kilometres or more);
c. language compatibility (with a value of 1.0 where native languages match, 0.8 where there is a shared fluent language, 0.2 for only basic overlap, and 0 for no overlap);
d. relevant experience (mapped from 0.0 for no experience to 1.0 for five or more years);
e. historical rating (mapped from 1 to 5 stars into 0.0 to 1.0);
f. availability and responsiveness (for example, 1.0 where the provider has explicitly marked availability and has a median response time under 5 minutes, 0.5 where availability is only passive, and 0 where there are conflicts); and
g. verification level (for example, 1.0 for full verification including identity, documents, phone, and email, 0.7 for partial verification, 0.3 for minimal checks, and 0 for none).

Tie-breaker logic is applied when the compatibility score S for two or more candidates is equal within ±0.01. The system resolves such ties in the following strict order. First, it prefers the candidate with the higher verificationStatus, with verified ranked above pending and pending above declined. Second, it prefers the candidate with the lower risk score R. Third, it prefers the candidate with the lower cancellationRate and, if still tied, the lower disputeCount. Fourth, it prefers the candidate with the higher rating. Fifth, it prefers the candidate with the better price_fit, meaning a price closer to the seeker's budget. Sixth, if a tie remains, it prefers the candidate with the more recent lastActive timestamp.

Illustrative weights may assign relatively higher importance to flight match, geographical proximity, and language compatibility, with smaller but non-trivial weights for experience, rating, availability, and verification. In an example, three providers are scored against the same request. A first provider with a perfect flight match, close proximity, a full language match, several years of experience, a high rating, explicit availability, and full verification attains the highest S. A second provider with weaker flight and distance alignment and partial verification attains a moderate S. A third provider with no flight or language match and poor proximity, despite strong experience and verification, attains a low S. Where two candidates have very similar S values (for example within two percentage points), the system may apply tie-breakers based first on higher verification, then higher rating, then earlier registration date.

In a worked example with four candidates, the system uses weights w=[0.20, 0.20, 0.15, 0.10, 0.10, 0.15, 0.10] applied respectively to the normalized features [Prox, Avail, Skill, Lang, Price, Trust, Activity]. Candidate A has normalized features [0.90, 0.80, 1.00, 0.80, 0.70, 0.60, 0.90], yielding S_A=0.2×0.90+0.2×0.80+0.15×1.00+0.1×0.80+0.1×0.70+0.15×0.60+0.1×0.90=0.82. Candidate B has normalized features [0.70, 0.90, 0.80, 0.70, 0.90, 0.70, 0.80], yielding S_B=0.2×0.70+0.2×0.90+0.15×0.80+0.1×0.70+0.1×0.90+0.15×0.70+0.1×0.80=0.785. Candidate C has normalized features [0.60, 0.50, 0.90, 0.90, 0.60, 0.80, 0.60], yielding S_C=0.685. Candidate D has normalized features [0.85, 0.70, 0.70, 0.60, 0.50, 0.90, 0.70], yielding S_D=0.73. On this basis, the ranking is A (0.82) >B (0.785) >D (0.73) >C (0.685). If two candidates were tied within the defined tolerance, for example if B and D were equal, the tie-breaker would prefer the candidate with the higher verification status and the lower risk score R, followed by the other tie-break criteria specified elsewhere.

The disclosed risk-aware control loop reduces the need for manual intervention by enabling trustworthy automation under defined and inspectable rules. Because the decision engine records the signals used, the thresholds applied, and the resulting connection states, operators can rely on automated approvals and blocks with greater confidence, while retaining the ability to review and adjust behaviour based on recorded evidence rather than opaque heuristics.

The staged and tokenised disclosure of user information provides improved privacy protection and a concrete technical mechanism for limiting exposure of personal identifiers. Information is revealed progressively in dependence on the connection state and associated risk level, rather than being exposed immediately upon listing or initial contact. Tokenisation and controlled detokenisation ensure that sensitive fields are handled only by authorised components, and that logs and external services do not contain unnecessary raw identifiers, thereby reducing attack surface and data leakage risk.

The system enhances resistance to fraud and abuse through the combination of monotonic, auditable risk models, explicit pairwise risk assessment, specialised client and kiosk devices acting as trusted endpoints, and wallet and payout logic that is conditioned on verifiable proof-of-service or proof-of-travel events. These measures provide a technical basis for detecting anomalous behaviour, withholding or reversing incentives when necessary, and preventing misuse of the platform's financial and matching mechanisms.

The secure and idempotent signalling framework for real-time communication improves robustness and integrity of calls and session-related events. By authenticating signalling with strong tokens, enforcing sequence-numbered, replay-resistant processing, and persisting call lifecycle data, the platform can reliably determine when and how communications occurred, compute deterministic call durations, and enable or disable communication channels in alignment with the connection states determined by the orchestration engine.

The internationalisation mechanism using version identifiers and delta bundles yields a technical advantage in bandwidth efficiency and consistency of client behaviour. Clients are able to determine whether updates are required and obtain only changed localisation keys, which reduces unnecessary network traffic while ensuring that user interfaces remain aligned with current policies and messages across a distributed deployment.

The hybrid retrieval and context-grounded AI support capability provides more accurate and controlled automated assistance. By constraining AI responses to retrieved, curated knowledge and applying the same redaction and disclosure rules used elsewhere in the platform, the system delivers useful support outputs while preserving privacy and preventing inadvertent disclosure of internal thresholds or sensitive data. This results in a technically improved support channel that is integrated into, and governed by, the platform's overall trust and policy framework.

The use of structured decision records, configuration and model versioning, and comprehensive logging improves transparency, auditability and maintainability. Every significant automated decision can be reconstructed with reference to the precise configuration, model parameters and inputs in effect at the time. This facilitates debugging, verification of correct operation, assessment of fairness and regulatory compliance, and safe evolution of models and policies without loss of accountability.

Collectively, these features provide a cohesive, technically robust solution to the problems of secure, risk-aware, privacy-preserving matching and coordination on networked platforms, implemented through concrete mechanisms at the client, server, data, and policy layers. The described system produces an integrated technical effect that is not achieved by conventional, loosely coupled marketplace, communication and scoring components.

### Further Example Embodiments

Further example embodiments are described by the following clauses:

Clause 1. A service matching system (100) for matching a service request user and a collocated service provider, the system comprising:
a matching server (102) with a database (104) of user and service provider data; and
a plurality of client devices (106) in communication with the matching server (102) via a communication network (108),
wherein the matching server (102) comprises a processor configured to:
   receive a match request from the user, the match request comprising match parameters comprising a physical location;
   retrieve service provider profiles from the database based on the match parameters;
   compare the match parameters with service provider profile parameters to identify one or more matching service providers;
   output a service request to the one or more matching service providers;
   upon receiving a service accept message from a matching service provider, assign a service provider; and
   connect a client device associated with the match request and a client device associated with the assigned service provider.

Clause 2. A computer-implemented method for matching a user and a collocated service provider, the method comprising:
receiving a match request from the user, the match request comprising match parameters comprising a physical location;
retrieving service provider profiles from the database based on the match parameters; comparing the match parameters with service provider profile parameters to identify one or more matching service providers;
outputting a service request to the one or more matching service providers;
upon receiving a service accept message from a matching service provider, assigning a service provider;
connecting a client device associated with the match request and a client device associated with the assigned service provider.

Clause 3. A data processing system comprising means for carrying out the method of clause 2.

Clause 4. A computer program comprising instructions which, when the program is executed by a computer, cause the computer to carry out the method of clause 2.

Clause 5. A computer-readable medium comprising instructions which, when executed by a computer, cause the computer to carry out the method of clause 2.

It will be understood to persons skilled in the art of the invention that many modifications may be made without departing from the spirit and scope of the invention.

1. A computer-implemented method for controlling connection of users on a networked platform, the method comprising, by one or more processors:
receiving, from a first user, a request for a prospective interaction in a defined context;
identifying a set of candidate counterpart users;
for each candidate counterpart user, computing a compatibility score based on attributes of the first user, the candidate counterpart user and the context;
for each of the first user and each candidate counterpart user, computing a respective profile risk score using a machine-learned model trained with monotonic constraints such that increases in verification or positive history do not increase the profile risk score and increases in adverse indicators do not decrease the profile risk score;
for each candidate counterpart user, computing a pairwise risk score for the prospective interaction as a function of at least the corresponding profile risk scores and one or more context factors;
by an orchestration engine, applying one or more decision policies to the compatibility score, the profile risk scores and the pairwise risk score to select, for each candidate counterpart user, one of a plurality of connection states comprising at least an approved state, a conditional state and a blocked state;
and by the orchestration engine, controlling disclosure of user information between the first user and the candidate counterpart user in dependence on the selected connection state, including causing only redacted or pseudonymous information to be disclosed while in one or more initial states and causing additional identifying information or communication capabilities to be disclosed only upon transition to one or more authorised connection states.

2. The method of claim 1, wherein computing the compatibility score comprises normalising a plurality of features to values within a fixed numerical range according to predefined scaling rules and combining the normalised features using a weighted sum with weights selected to reflect relative importance of at least route or location alignment, schedule alignment, skills or capability match, communication or language match, historical reliability, and verification status.

3. The method of claim 1, wherein computing each profile risk score comprises applying an ensemble machine-learned model comprising gradient-boosted decision trees trained on historical labelled data distinguishing incident-free users from users associated with confirmed fraud, abuse or repeated policy breaches, enforcing monotonic constraints for at least selected verification and incident count features, and calibrating an output of the model using isotonic regression or Platt scaling to obtain a probability-like value within a predetermined range.

4. The method of claim 1, wherein computing the pairwise risk score comprises combining the profile risk scores of the first user and the candidate counterpart user with one or more context risk indicators selected from time of day, location category, route category and sensitivity of the requested service, using a function configured such that the pairwise risk score is non-decreasing with respect to each of its inputs.

5. The method of claim 1, wherein the decision policies comprise threshold conditions defined over both the compatibility score and the pairwise risk score, including at least: a first region in which the compatibility score exceeds a first threshold and the pairwise risk score is below a first limit, causing selection of the approved state;
a second region in which the compatibility score and the pairwise risk score fall within intermediate bounds, causing selection of the conditional state;
and a third region in which the pairwise risk score exceeds a second limit, causing selection of the blocked state.

6. The method of claim 1, wherein controlling disclosure of user information comprises maintaining, for each connection state, a disclosure policy specifying which profile fields are permitted to be displayed, evaluating the disclosure policy when generating a user interface view or message, and suppressing at least direct contact identifiers, precise locations and full legal names in the initial states while permitting display of such identifiers only in authorised connection states.

7. The method of claim 1, wherein causing redacted or pseudonymous information to be disclosed in the initial states comprises generating deterministic tokens for sensitive fields using a keyed cryptographic function, storing mappings between tokens and underlying values in an access-controlled data store separate from general application data, and transmitting only the tokens to client devices until an authorised connection state is reached.

8. The method of claim 1, further comprising generating, in association with at least one of the compatibility score, the profile risk scores, the pairwise risk score and the selected connection state, explanation data identifying one or more input features and corresponding contributions that influenced the scores, and storing the explanation data in a decision record retrievable by an administrative interface.

9. The method of claim 1, further comprising generating, for each selected connection state, a machine-readable decision record including at least identifiers of the users concerned, the compatibility score, the profile risk scores, the pairwise risk score, the selected connection state, a timestamp, and identifiers of versions of at least one of: a compatibility scoring configuration, a risk model configuration, and a disclosure policy configuration used when making the decision, thereby enabling later reconstruction of the decision.

10. The method of claim 1, further comprising monitoring, after a connection has been established in the approved state or conditional state, for new risk-relevant signals including at least one of payment chargebacks, complaints, abuse reports, anomalous device or network behaviour, and updated verification results, and, in response to detecting such a signal for a user, recomputing the profile risk score and the pairwise risk score for each active connection involving that user and reapplying the decision policies to determine whether to maintain, downgrade to a conditional or review state, or transition to the blocked state.

11. The method of claim 1, wherein transitioning from an approved state to a conditional or blocked state in response to recomputed scores comprises at least one of: disabling or limiting in-app messaging or calling between the users;
reverting previously disclosed identifiers to pseudonymous tokens;
notifying an administrator with the associated decision record and explanation data;
and preventing further bookings or interactions between the affected users unless and until the state is changed.

12. The method of claim 1, further comprising periodically analysing decision records to compute one or more fairness metrics indicative of differences in automatic approval or blocking rates between groups defined using monitoring attributes that are not used as inputs to the compatibility or risk models, and generating an alert or recommendation to adjust configurations when a fairness metric departs from a specified range.

13. The method of claim 1, wherein at least a portion of the orchestration engine is executed within a secure execution environment or hardware security module configured to store cryptographic keys, risk model parameters and disclosure policies, and to produce signed attestations for decision records, enabling verification that the decisions were generated by an authorised orchestration component.

14. The method of claim 1, wherein at least one client device that presents match information or user data is configured as a restricted client device that stores device credentials and policy data in secure storage, executes only approved client software, communicates with the platform only over authenticated and encrypted connections, and enforces restrictions on exporting or capturing displayed personal data, such that enforcement of the connection states and disclosure policies extends to said client device.

15. A system for controlling connection of users on a networked platform, the system comprising one or more processors, one or more memories storing instructions and data including user profiles, configuration data and model parameters, and one or more network interfaces, wherein the instructions, when executed by the one or more processors, cause the system to perform the method of claim 1.

16. A non-transitory computer-readable medium storing instructions which, when executed by one or more processors, cause a system to perform the method of claim 1.
